(19) United States
(12) Patent Application Publication
(10) Pub. No.: US 2013/0308012 A1
(43) Pub. Date: Nov. 21, 2013

(54) IMAGE PROCESSING APPARATUS, IMAGE PROCESSING METHOD, PHOTOGRAPHIC IMAGING APPARATUS, AND RECORDING DEVICE RECORDING IMAGE PROCESSING PROGRAM

(71) Applicant: OLYMPUS CORPORATION, Tokyo (JP)

(72) Inventor: Takeshi FUKUTOMI, Tokyo (JP)

(73) Assignee: OLYMPUS CORPORATION, Tokyo (JP)

(21) Appl. No.: 13/949,878

(22) Filed: Jul. 24, 2013

Related U.S. Application Data
(63) Continuation of application No. PCT/JP2011/077982, filed on Dec. 2, 2011.

(30) Foreign Application Priority Data
Feb. 8, 2011 (JP) 2011-025122

(51) Int. Cl. H04N 5/235

(52) U.S. Cl. CPC H04N 5/2353
USPC 348/229.1

(57) ABSTRACT

An image processing apparatus includes: a gray-scale conversion characteristic deriving unit that sets a reference image out of a plurality of input images obtained by shooting an identical object with a different amount of exposure and derives a gray-scale conversion characteristic from the reference image; a normalizing unit that generates a correction image by correcting brightness of the reference image based on an amount of exposure of the reference image and an amount of exposure of a non-reference image other than the reference image; a position alignment processing unit that computes a positional deviation between the correction image and the non-reference image and generates a position alignment image by aligning a position of the non-reference image with the reference image based on the positional deviation; and an image synthesis processing unit that derives a new pixel value for each pixel using a pixel value of a single or a plurality of images selected out of a plurality of the input images based on the gray-scale conversion characteristic to generate a synthesized image.

### CROSS REFERENCE TO RELATED APPLICATIONS

This application is a continuation of International Patent Application No. PCT/JP2011/77982, filed on Dec. 2, 2011, which claims the benefit of Japanese Patent Application No. JP 2011-25122, filed on Feb. 8, 2011, which are incorporated by reference as if fully set forth.

### FIELD OF THE INVENTION

The present invention relates to a technology of obtaining an image having an improved gray scale (gradation) by synthesizing image data for a plurality of frames obtained by shooting an identical object with a different amount of exposure.

### BACKGROUND OF THE INVENTION

In a back light shooting condition under an open-air clear sky, an object luminance range within a scene (hereinafter, simply referred to as a “luminance range”) is widened. When the object having a wide luminance range is shot using a digital camera, the resulting scene may not be suitable for a dynamic range recordable by a photographic imaging system or an image signal processing system. In this case, a so-called shadow phenomenon in which an image is blocked up occurs in a dark portion of an image. Similarly, a so-called highlight phenomenon in which an image is blown out occurs in a bright portion of an image.

As a technique for avoiding such a phenomenon, there is known a high dynamic range (HDR) imaging technique (hereinafter, referred to as a “HDR technique”). In the HDR technique, a shooting is performed in a plurality of tries for an identical scene by changing a shutter speed so that a plurality of image data are obtained with a different amount of exposure. Then, a synthesis processing is performed such that a pixel value of the image data obtained with a relatively large amount of exposure is used in an area where a shadow phenomenon may occur in an image, and a pixel value of the image data obtained with a relatively small amount of exposure is used in an area where a highlight phenomenon may occur. As a result, it is possible to obtain an image in which a gray scale is appropriately reproduced from a dark portion to a bright portion.

Japanese Patent Application Laid-open No. 06-141229 (JP06-141229A) discloses a technique of obtaining two or more images with a different electric charge storing time, adding the two or more images by applying a weight depending on a signal level of each image, and compressing the obtained signal level having a wide dynamic range to a reference level.

In the technique disclosed in Japanese Patent Application Laid-open No. 06-141229, it is necessary to increase a bit width (bit depth) when a plurality of signals are synthesized. For this reason, a necessary hardware size increases. In order to address such a problem, Japanese Patent Application Laid-open No. 2004-266347 (JP2004-266347A) discloses a technique of suppressing increase of the bit width (number of bits) of the image signal by performing a process of non-linearly compressing a high level part of the image signal and then synthesizing a plurality of images with a predetermined weight.

### SUMMARY OF THE INVENTION

According to an embodiment of the present invention, there is provided an image processing apparatus comprising: a gray-scale conversion characteristic deriving unit that sets a reference image out of a plurality of input images obtained by shooting an identical object with a different amount of exposure and derives a gray-scale conversion characteristic from the reference image; a normalizing unit that generates a correction image by correcting brightness of the reference image based on an amount of exposure of the reference image and an amount of exposure of a non-reference image other than the reference image; a position alignment processing unit that computes a positional deviation between the correction image and the non-reference image and generates a position alignment image by aligning a position of the non-reference image with respect to the reference image based on the positional deviation; and an image synthesis processing unit that derives a new pixel value for each pixel using a pixel value of a single or a plurality of images selected out of the reference image and the position alignment image based on the gray-scale conversion characteristic to generate a synthesized image.

According to another embodiment of the present invention, there is provided an image processing method comprising: setting a reference image out of a plurality of input images obtained by shooting an identical object with a different amount of exposure; deriving a gray-scale conversion characteristic from the reference image; generating a correction image by correcting brightness of the reference image based on an amount of exposure of the reference image and an amount of exposure of a non-reference image other than the reference image; computing a positional deviation between the correction image and the non-reference image and generating a position alignment image by aligning a position of the non-reference image with respect to the reference image based on the positional deviation; and deriving a new pixel value for each pixel using a pixel value of a single or a plurality of images selected from the reference image and the position alignment image based on the gray-scale conversion characteristic to generate a synthesized image.

According to still another embodiment of the present invention, there is provided a computer readable recording device having an image processing program encoded and recorded thereon in a computer readable format, the image processing program performing a process of generating a synthesized image having an improved gray scale by synthesizing a plurality of input images obtained by shooting an identical object with a different amount of exposure, wherein the image processing program causes a computer to execute a method comprising: a reference image setting step of setting a reference image out of a plurality of the input images; a gray-scale conversion characteristic deriving step of deriving a gray-scale conversion characteristic from the reference image; a normalizing step of generating a correction image by correcting brightness of the reference image based on an amount of exposure of the reference image and an amount of exposure of a non-reference image other than the reference image; a position alignment processing step of computing a positional deviation between the correction image and the non-reference image and generating a position alignment image by aligning a position of the non-reference image with respect to the reference image based on the positional deviation; and an image synthesis step of deriving a new pixel value for each pixel using a pixel value of a single or a plurality of images selected from the reference image and the position alignment image based on the gray-scale conversion characteristic to generate a synthesized image.

According to further another embodiment of the present invention, there is provided a photographic imaging apparatus having an image pickup unit capable of photoelectrically converting an object image formed by a photographic lens and outputting an image signal, the photographic imaging apparatus comprising: a shooting control unit that obtains a plurality of input images by shooting an identical object with a different amount of exposure, using the image pickup unit; a gray-scale conversion characteristic deriving unit that sets a reference image out of a plurality of the input images and derives a gray-scale conversion characteristic from the reference image; a normalizing unit that generates a correction image by correcting brightness of the reference image based on the amount of exposure of reference image and an amount of exposure of a non-reference image other than the reference image; a position alignment processing unit that computes a positional deviation between the correction image and the non-reference image and generates a position alignment image by aligning a position of the non-reference image with the reference image based on the positional deviation; and an image synthesis processing unit that derives a new pixel value for each pixel using a pixel value of a single or a plurality of images selected from the reference image and the position alignment image based on the gray-scale conversion characteristic to generate a synthesized image.

The foregoing and additional features and characteristics of this disclosure will become more apparent from the following detailed description considered with the reference to the accompanying drawings.

### BRIEF DESCRIPTION OF THE DRAWINGS

FIG. 1 is a block diagram illustrating a schematic configuration of a digital camera;

FIG. 2 is a block diagram illustrating a schematic internal configuration of a computer, in which an image processing unit is implemented by causing a computer to execute an image processing program;

FIG. 3 is a block diagram illustrating a schematic configuration of the image processing unit;

FIG. 4 is a diagram conceptually illustrating a gray-scale conversion characteristic derived by the image processing unit and how to derive gray-scale conversion characteristic information from reference image data based on the gray-scale conversion characteristic;

FIG. 5A is a diagram illustrating a histogram of pixel values of the reference image data;

FIG. 5B is a diagram illustrating a cumulative frequency curve of pixel values of the reference image data;

FIG. 5C is a diagram illustrating an example of the gray-scale conversion characteristic curve derived based on the cumulative frequency curve of the pixel values of the reference image data;

FIG. 6 is a block diagram schematically illustrating an internal configuration of an image synthesis processing unit provided in an image processing unit according to a first embodiment;

FIG. 7 is a diagram conceptually illustrating an image selection/mixing process performed in the image synthesis processing unit provided in the image processing unit according to the first embodiment;

FIG. 8 is a flowchart illustrating an image synthesis processing sequence executed by the image processing unit according to the first embodiment;

FIG. 9 is a flowchart illustrating details of a part of the image synthesis processing sequence executed by the image processing unit according to the first embodiment;

FIG. 10 is a block diagram illustrating a schematic configuration of the image processing unit according to a second embodiment;

FIG. 11A is a flowchart illustrating a first process of the image synthesis processing sequence executed by the image processing unit according to the second embodiment;

FIG. 11B is a flowchart illustrating the second to (n−2)th process of the image synthesis processing sequence executed by the image processing unit according to the second embodiment;

FIG. 11C is a flowchart illustrating the (n−1)th process of the image synthesis processing sequence executed by the image processing unit according to the second embodiment;

FIG. 12 is a block diagram illustrating a schematic configuration of the image processing unit according to a third embodiment;

FIG. 13 is a diagram illustrating a dissimilarity function according to the third embodiment;

FIG. 14 is a flowchart illustrating the image synthesis processing sequence executed by the image processing unit according to the third embodiment;

FIG. 15 is a flowchart illustrating details of a part of the image synthesis processing sequence executed by the image processing unit according to the third embodiment;

FIG. 16 is a block diagram illustrating a schematic configuration of the image processing unit according to a fourth embodiment;

FIG. 17A is a flowchart illustrating the first process of the image synthesis processing sequence executed by the image processing unit according to the fourth embodiment;

FIG. 17B is a flowchart illustrating the second to (n−2)th process of the image synthesis processing sequence executed by the image processing unit according to the fourth embodiment; and

FIG. 17C is a flowchart illustrating the (n−1)th process of the image synthesis processing sequence executed by the image processing unit according to the fourth embodiment.

### DESCRIPTION OF THE PREFERRED EMBODIMENT

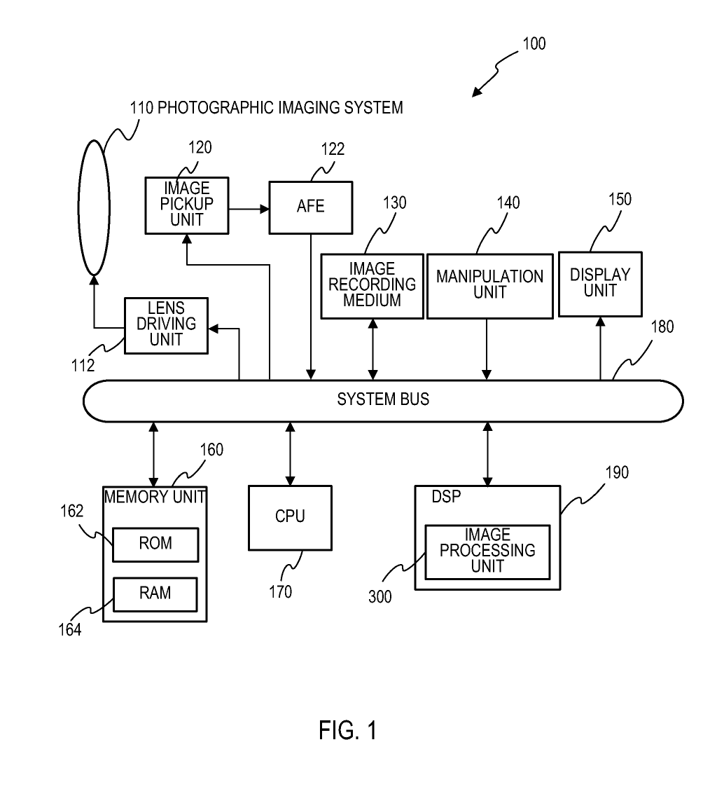

FIG. 1 is a block diagram illustrating a schematic configuration of a digital camera 100. The digital camera 100 may be a still camera or a movie camera. The digital camera 100 may be integrated into a mobile phone and the like. When the digital camera 100 is a still camera or a movie camera, a photographic lens may be a fixed type or an exchangeable type.

The digital camera 100 includes: a photographic optical system 110; a lens driving unit 112; an image pickup unit 120; an analog front end (denoted by “AFE” in FIG. 1) 122; an image recording medium 130; a manipulation unit (operation unit) 140; a display unit 150; a memory unit 160; a central processing unit (CPU) 170; a digital signal processor (DSP) 190; and a system bus 180. The memory unit 160 includes a read-only memory (ROM) 162 and a random access memory (RAM) 164. An image processing unit 300 is integrated into the DSP 190.

The lens driving unit 112, the image pickup unit 120, the analog front end 122, the image recording medium 130, the manipulation unit 140, the display unit 150, the memory unit 160, the CPU 170, and the DSP 190 are electrically connected to one another via a system bus 180. The RAM 164, the CPU 170, and the DSP 190 are accessible to one another.

The photographic optical system 110 forms an object image on a light-receiving area of the image pickup unit 120. The lens driving unit 112 performs a focal point adjustment operation of the photographic optical system 110. In a case where the photographic optical system 110 is a variable focal point optical system, the photographic optical system 110 may be driven by the lens driving unit 112 to change a focal length.

The image pickup unit 120 includes a shutter and an image pickup element. Object light transmitting through the photographic optical system 110 is incident to the image pickup element while the shutter is opened. The object image formed on the light-receiving area of the image pickup element is photoelectrically converted to generate an analog image signal. In a case where the image pickup element has a functionality of an electronic shutter capable of electrically controlling an exposure time (photoelectrical conversion time), the mechanical shutter may be dispensable. The analog image signal is input to the analog front end 122. The analog front end 122 performs noise reduction, signal amplification, analog/digital (A/D) conversion, and the like to generate a digital image signal. This digital image signal is temporarily stored in the RAM 164.

The DSP 190 applies various digital signal processings such as demosaicing, gray-scale conversion, color balance correction, shading correction, and noise reduction to the digital image signal temporarily stored in the RAM 164. In addition, the DSP 190 records the digital image signal in the image recording medium 130 or outputs the digital image signal to the display unit 150 as necessary.

The image recording medium 130 includes a flash memory, a magnetic recording device, and the like and is detachably installed in the digital camera 100. Alternatively, the image recording medium 130 may be integrated into the digital camera 100. In this case, an area for recording image data may be prepared inside the ROM 162 and may be used as the image recording medium 130.

The manipulation unit 140 includes any one of or a plurality of types including a push switch, a slide switch, a dial switch, a touch panel, and the like to receive user manipulation. The display unit 150 includes a thin-film transistor (TFT) liquid crystal display panel and a backlight unit, or a self-emissive type display device such as an organic electroluminescence display device to display information such as images, text, and the like. In addition, the display unit 150 has a display interface, so that the image data written to a video RAM (VRAM) area provided in the RAM 164 is read by the display interface to display information such as images or text on the display unit 150.

The ROM 162 includes a flash memory or the like and stores a control program (firmware) executed by the CPU 170, an adjustment parameter, information necessary to be stored while the digital camera 100 is powered off, and the like. The RAM 164 includes a synchronous dynamic RAM (SDRAM) or the like and is accessible at a relatively high speed. The CPU 170 analyzes and executes the firmware transmitted from the ROM 162 to the RAM 164 and generally controls the operation of the digital camera 100.

The DSP 190 applies various processings described above to the digital image signal temporarily stored in the RAM 164 to generate recording image data, display image data, and the like.

The digital camera 100 is capable of executing an operation of shooting a still image in a high dynamic range (HDR) shooting mode. That is, the digital camera 100 may be operated such that a plurality of image data are obtained by shooting an identical object with a different amount of exposure, and synthesized image data having an improved gray scale (gradation or tone) are created from a plurality of the image data. Naturally, the digital camera 100 may perform a moving picture shooting in the HDR shooting mode. In this case, the shooting is performed by changing the amount of exposure at a frame rate greater than the recording frame rate of the moving picture, and image data for a single frame is created from a plurality of the obtained image data so that created image data is recorded. By the way, it is desirable that the shooting is performed using the same composition when the identical object is shot with a different amount of exposure as described above. That is, in order to obtain better quality synthesized image data, it is desirable that a plurality of images obtained through a series of shootings have the same scene except that the amount of exposure is different. However, in some cases, a shooting range may slightly change during the shooting operation if the handheld shooting is performed, or a position or shape of the object may change within the scene if the object is movable. In such cases, processings such as position alignment, image cutting, or pasting may be performed based on a pattern matching technique to synthesize an image.

When the shooting operation is performed by changing the amount of exposure as described above, the CPU 170 as an image pickup control unit controls the image pickup unit 120 such that a determined number of exposure processes are performed with the amount of exposure determined for each exposure process. That is, the CPU 170 controls the image pickup unit 120 such that the identical object is shot with a different amount of exposure to obtain a plurality of image data.

The digital camera 100 may have a plurality of photographic imaging systems, each of which includes the photographic optical system 110, the lens driving unit 112, the image pickup unit 120, and the like. In this case, it is possible to approximately simultaneously obtain images from each photographic imaging system with a different amount of exposure using a plurality of photographic imaging systems in response to a single release manipulation from a user. Using this configuration, it is possible to obtain a plurality of images with a different amount of exposure for each frame at the time of the moving picture shooting.

Alternatively, the digital camera 100 may include a plurality of image pickup units 120. In this case, in the digital camera 100, a beam splitter (optical path splitting member) may be disposed in the rear side of the photographic optical system 110, and the image pickup units 120 may be disposed on a plurality of optical paths split by the beam splitter. The beam splitter splits a light beam at an unequal splitting ratio. For example, in a case where the beam splitter splits and emits an input light beam into a pair of light beams, the beam splitter may be designed such that a ratio between a light amount of the light beam emitted along one optical path and a light amount of the light beam emitted along the other optical path is set to, for example, 1:4. In such a beam splitter configuration, a shutter speed (exposure time) or an aperture stop set in the photographic optical system 110 has the same exposure condition for each image pickup unit 120. However, the light amount of the object light incident to each image pickup unit 120 is different due to the effect of the beam splitter. As a result, it is possible to obtain a plurality of images with a different amount of exposure through a single shooting operation. In this configuration, it is possible to obtain a plurality of images with a different amount of exposure through a single exposure operation. Using this configuration, it is possible to obtain a plurality of images with a different amount of exposure for each frame at the time of the moving picture shooting.

In order to obtain a plurality of images with a different amount of exposure, any one of the three methods described above may be employed. That is, as a first method, the exposure operation is sequentially performed several times by changing the exposure condition. As a second method, different exposure conditions are set for each of the photographic imaging systems, and the shooting is performed approximately simultaneously. As a third method, the object light is guided to a plurality of image pickup elements at a different splitting ratio using the optical path splitting member disposed in the rear side of a single photographic optical system, so that a plurality of images with a different amount of exposure are obtained through a single exposure operation.

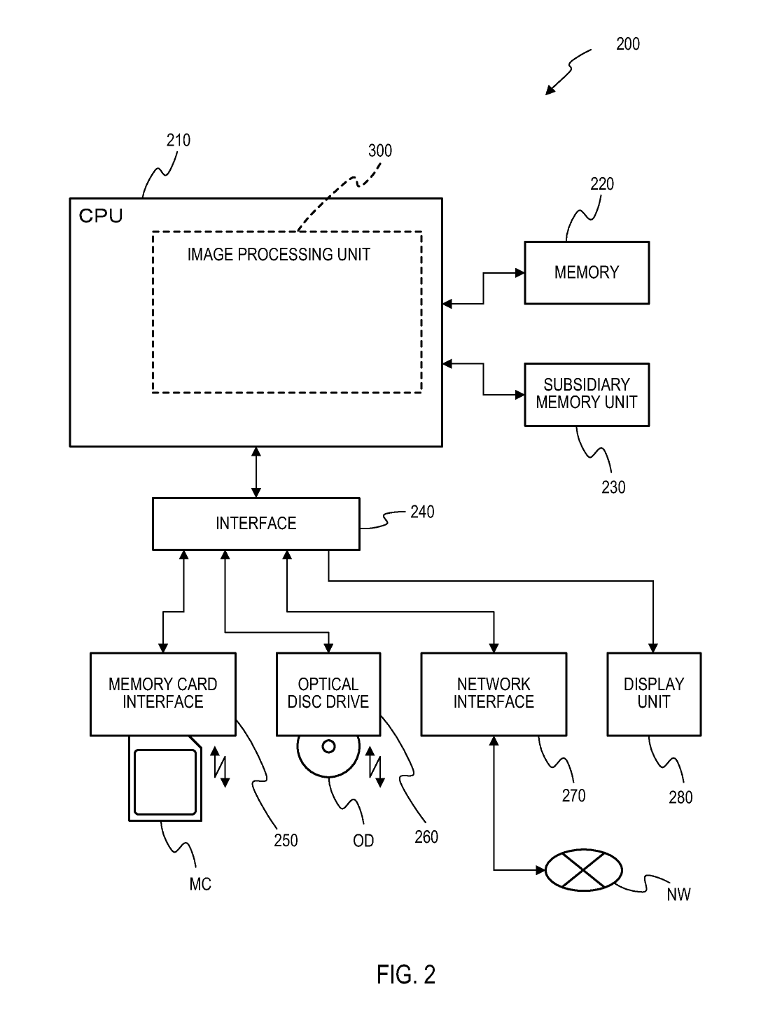

FIG. 2 is a block diagram illustrating an example in which an image processing program recorded in a recording medium is read and executed by a CPU of a computer to implement a functionality of the image processing unit 300. The computer 200 includes a CPU 210, a memory 220, a subsidiary memory unit 230, an interface 240, a memory card interface 250, an optical disc drive 260, a network interface 270, and a display unit 280. The CPU 210, the memory card interface 250, the optical disc drive 260, the network interface 270, and the display unit 280 are electrically connected to one another via an interface 240.

The memory 220 is a memory accessible at a relatively high speed, such as a double data rate (DDR) SDRAM. The subsidiary memory unit 230 includes a hard disc drive or a solid-state drive (SSD) having a relatively large storage capacity.

The memory card interface 250 is configured such that the memory card MC can be detachably installed. The image data created through a shooting operation using the digital camera and the like and stored in the memory card MC may be read to the computer 200 through the memory card interface 250. Alternatively, the image data in the computer 200 may be written to the memory card MC.

The optical disc drive 260 is configured to read data from the optical disc OD. Alternatively, the optical disc drive 260 may be configured to write data onto the optical disc OD as necessary.

The network interface 270 is configured to exchange information between the computer 200 and an external information processing apparatus such as a server connected via a network NW.

The display unit 280 includes a flat panel display device and the like to display text, icons, color images, and the like.

The image processing unit 300 is implemented by causing the CPU 210 to analyze and execute the image processing program loaded on the memory 220. This image processing program is encoded and recorded in a computer readable recording device (nonvolatile computer readable recording medium) such as a memory card MC or an optical disc OD using a computer readable format and is distributed to a user of the computer 200. Alternatively, the image processing program downloaded from an external information processing apparatus such as a server via a network NW may be stored in the subsidiary memory unit 230. Alternatively, the image processing program may be downloaded from an external information processing apparatus and the like through other types of wired/wireless interfaces and may be stored in the subsidiary memory unit 230.

The image processing unit 300 executes the following image processing for the image data stored in the subsidiary memory unit 230 or the image data input through the memory card MC, the optical disc OD, the network NW, and the like. Hereinafter, the processing in the image processing unit 300 according to first and second embodiments will be described.

### First Embodiment

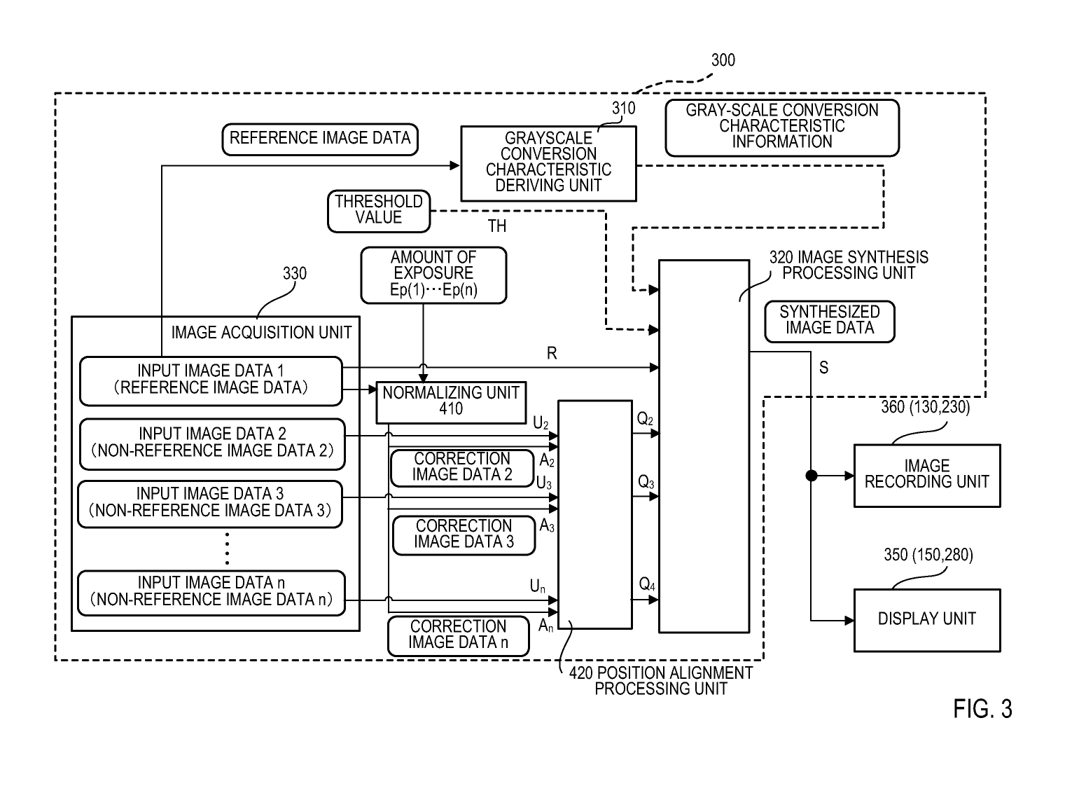

FIG. 3 is a block diagram schematically illustrating a configuration of the image processing unit 300 according to a first embodiment. As described above, the image processing unit 300 may be implemented by the DSP 190 of the digital camera 100 or may be implemented by causing the CPU 210 of the computer 200 to execute the image processing program.

The image processing unit 300 includes a gray-scale conversion characteristic deriving unit 310, an image synthesis processing unit 320, and an image acquisition unit 330. The image recording unit 360 connected to the image processing unit 300 corresponds to the image recording medium 130 and the subsidiary memory unit 230 described above in conjunction with FIGS. 1 and 2. Similarly, the display unit 350 connected to the image processing unit 300 corresponds to the display unit 150 or 280.

The image acquisition unit 330 obtains a plurality of input image data by shooting an identical object with a different amount of exposure. In order to obtain a plurality of input image data with a different amount of exposure, any one of the three methods described above may be employed. In the following description, it is assumed that the first method is employed, in which exposure is sequentially performed several times by changing the exposure condition. Hereinafter, the case where an identical object is sequentially shot several times with a different amount of exposure will be referred to as “exposure bracketing.” In this exposure bracketing, the amount of exposure may be controlled by changing a length of the exposure time in order to obtain a plurality of images having the same motion blur or aberration. Alternatively, the amount of exposure may be controlled by changing the aperture stop value if an exposure change step (correction step) in the exposure bracketing is small so that a variation of the motion blur or aberration obtained by changing the aperture stop does not matter in most cases. Alternatively, in a case where a neutral density (ND) filter insertable/extractable to/from an optical path of the object light is provided inside the photographic optical system 110 and the like, the images with a different amount of exposure may be obtained through an insertion-extraction switching of the ND filter.

In a case where the image processing unit 300 is implemented by the DSP 190 of the digital camera 100, the image acquisition unit 330 may obtain a plurality of input image data as follows. Specifically, the digital image signal is sequentially output from the analog front end 122 while exposure bracketing is performed in the digital camera 100. The image acquisition unit 330 may obtain a plurality of input image data obtained by causing the DSP 190 to process the digital image signal. Alternatively, the image acquisition unit 330 may obtain the input image data by reading a plurality of input image data recorded in the image recording unit 360 (image recording medium 130) through exposure bracketing in the past. In any case, the input image data may be obtained from so-called raw image data. In addition, the input image data may be image data having any format such as a red/green/blue (RGB) format or a luminance/chroma-blue/chroma-red (YCbCr) format subjected to a development process.

The number of input image data obtained by the image acquisition unit 330 may be set to any number n equal to or greater than 2. This number n may be a fixed value or a user definable value or may be automatically set based on a result obtained by detecting a luminance (brightness) distribution in an object image during a shooting preparation operation (during a live-view display operation). For example, in a case where a difference between the maximum luminance and the minimum luminance within an object image is relatively small as in a front light photographic condition under a cloudy sky, the number of exposure (number of input image data) in the exposure bracketing may be set to a relatively small value. In contrast, in a case where a difference between the maximum luminance of the brightest portion and the minimum luminance of the darkest portion within an object image is relatively large as in a back light photographic condition under a clear sky or a night scene, the number of exposure in the exposure bracketing may be set to a relatively large value. In this case, the correction step may be arbitrarily set by a user or may be automatically set.

In the following description, a plurality of input image data are referred to as input image data 1, input image data 2, input image data 3, . . . , and input image data n in the order of the amount of exposure (input image data 1 has a smallest amount of exposure). The amounts of exposure for obtaining input image data 1, input image data 2, input image data 3, . . . , and input image data n sequentially increase stepwise and are set to Ep(1), Ep(2), Ep(3), . . . , and Ep(n), respectively. For example, for convenient description purposes, assuming that the exposure correction step is set to 1 Ev, and the number of exposure is set to 5, the amounts of exposure may be set to +0 Ev (×1), +1 Ev (×2), +2 Ev (×4), +3 Ev (×8), and +4 Ev (×16) with respect to the smallest amount of exposure (That is, Ep(2)=2×Ep(1), Ep(3)=4×Ep(1), Ep(4)=8×Ep(1), and Ep(5)=16×Ep(1)).

From such input image data, a pixel value P(i, j) is obtained for a pixel position (i, j). Here, assuming that the number of pixels of an image in a vertical direction is set to Mv, and the number of pixels in a horizontal direction is set to Mh, i denotes an integer from 0 to (Mv−1), and j denotes an integer from 0 to (Mh−1). Hereinafter, pixel values of input image data 1, input image data 2, . . . , and input image data n in a predetermined pixel position (i, j) will be denoted by P₁(i, j), P₂(i, j), . . . , and Pₙ(i, j), respectively. In addition, input image data 1, input image data 2, . . . , and input image data n will be collectively denoted by input image data 1 to n. It is noted that the exposure correction step or the number of exposure described above may be arbitrarily set depending on an object or a purpose of a photographic work. In the exposure correction step, the amount of exposure may be set to change at an equal or unequal interval.

The gray-scale conversion characteristic deriving unit 310 selects one of a plurality of input image data 1 to n obtained by the image acquisition unit 330 as reference image data (data of a reference image R) and analyzes the reference image data to derive a gray-scale conversion characteristic (gradation conversion characteristic). Various methods may be employed to select the reference image data. For example, the input image data obtained with the smallest amount of exposure out of a plurality of input image data obtained through a series of exposure bracketing processes may be set to the reference image data. Alternatively, the input image data obtained with an intermediate amount of exposure or the input image data obtained with the largest amount of exposure may also be set as the reference image data. Alternatively, a histogram for a plurality of input image data may be analyzed, and the input image data in which the center of the pixel value distribution is not excessively biased to a bright side or a dark side may be set to the reference image data. According to the present embodiment, it is assumed that the image data (input image data 1) obtained with the smallest amount of exposure is set to the reference image data. The pixel value R(i, j) of the reference image R becomes P₁(i, j). The gray-scale conversion characteristic deriving unit 310 derives gray-scale conversion characteristic information corresponding to each pixel included in the reference image data based on the derived gray-scale conversion characteristic. The gray-scale conversion characteristic and the gray-scale conversion characteristic information will be described in detail below.

The reference image data is input to the gray-scale conversion characteristic deriving unit 310, the normalizing unit 410, and the image synthesis processing unit 320. The non-reference image data 2, . . . , and n as input image data other than the reference image data (data of non-reference images U₂, . . . , and Uₙ) are input to the position alignment processing unit 420. The input image data 2, the input image data 3, . . . , and the input image data n are set as non-reference image data 2, non-reference image data 3, . . . , and non-reference image data n, respectively. A pixel value Uₓ(i, j) of the non-reference image Uₓ becomes Pₓ(i, j). Here, x denotes an integer from 2 to n.

Since the amount of exposure of the reference image R is different from that of each non-reference image Uₓ, the normalizing unit 410 corrects the reference image R corresponding to the reference image data, generates correction image data 2, . . . , and correction image data n for the correction images A₂, . . . , and Aₙ, and inputs correction image data 2, . . . , and correction image data n to the position alignment processing unit 420. The normalizing unit 410 corrects brightness (pixel value) of the reference image R based on a ratio Ep(x)/Ep(1) between the amount of exposure Ep(1) of the reference image R and the amount of exposure Ep(x) of the non-reference image U. As described in the following Equation (1), the pixel value Aₓ(i, j) of the correction image Aₓ (where, x=2 to n) is obtained by multiplying Ep(x)/Ep(1) and the pixel value R(i, j) of the reference image R.

$$\begin{matrix}[ Equation 1 ] & \\ PIXEL VALUE {A}_{x} ( i , j ) = \frac{Ep ( x )}{Ep ( 1 )} * R ( i , j ) & ( 1 )\end{matrix}$$

The position alignment processing unit 420 generates a position alignment image Qₓ (where, x=2 to n) by aligning a position of each non-reference image Uₓ with the reference image R. Since the amount of exposure of the reference image R is different from that of the non-reference image Uₓ, the position alignment processing unit 420 computes a positional deviation between the correction image Aₓ subjected to correction of brightness of the reference image R and the non-reference image Uₓ and aligns a position of the non-reference image Uₓ with the reference image R based on the computed positional deviation. For example, the position alignment processing unit 420 computes a positional deviation between the correction image Aₓ and the non-reference image Uₓ as a motion vector using a block matching method and modifies the non-reference image Uₓ based on the motion vector to generate the position alignment image Qₓ. The position alignment processing unit 420 inputs data of the position alignment images Q₂, . . . , and Qₙ (position alignment image data 2, . . . , and position alignment image data n) to the image synthesis processing unit 320. Hereinafter, the reference image R and the position alignment images Q₂, . . . , and Qₙ are often referred to as original images W₁, . . . , and Wₙ used in the processing of the image synthesis processing unit 320. The original image W₁ corresponds to the reference image R, and the original images W₂, . . . , and Wₙ correspond to the position alignment images Q₂, . . . , and Qₙ, respectively.

The image synthesis processing unit 320 generates a synthesized image S from a single or a plurality of images selected from the original images W₁, . . . , and Wₙ (corresponding to the reference image R and the position alignment images Q₂, . . . , and Qₙ). The image synthesis processing unit 320 compares the gray-scale conversion characteristic information (values regarding the gray-scale conversion characteristic) G(i, j) and the threshold value TH₁ to THₙ. In addition, the image synthesis processing unit 320 selects a single or a plurality of images from the original images W₁, . . . , and Wₙ depending on the comparison result and performs correction or weighted-averaging (weighted sum) for the selected image. The image synthesis processing unit 320 sets the threshold value THₖ (integer k=1 to n) based on the amount of exposure Ep(1) of the reference image R and the amount of exposure Ep(k) of each non-reference image Uₖ. According to the present embodiment, the threshold value THₖ (where, integer k=1 to n) is a ratio Ep(k)/Ep(1) of the amount of exposure between the reference image R and each non-reference image Uₖ. For example, in a case where a value of the gray-scale conversion characteristic information G(i, j) is between a pair of threshold values THₖ₋₁ and THₖ, the image synthesis processing unit 320 mixes pixel values (a pair of pixel values Wₖ₋₁(i, j) and Wₖ(i, j)) of the corresponding pixel position (i, j) out of a pair of the selected original images Wₖ₋₁ and Wₖ at a certain mixing ratio (weight) by weighted-averaging them. The mixing ratio is derived based on a relationship between a value of the gray-scale conversion characteristic information G(i, j) and a pair of threshold values THₖ₋₁ and THₖ.

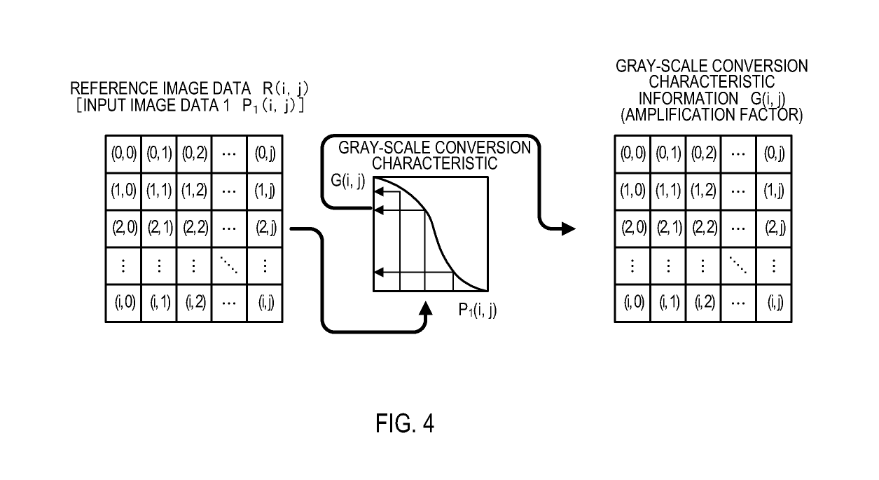

FIG. 4 is a diagram illustrating an exemplary gray-scale conversion characteristic derived by the gray-scale conversion characteristic deriving unit 310. As described above, according to the present embodiment, it is assumed that the reference image data is the input image data 1. The gray-scale conversion characteristic deriving unit 310 analyzes the reference image data to derive the gray-scale conversion characteristic. Here, the gray-scale conversion characteristic information denoted by G(i, j) is derived for the pixel value R(i, j) (=P₁(i, j)) in the pixel position (i, j) out of the reference image data (input image data 1). That is, the gray-scale conversion characteristic is a characteristic for deriving the gray-scale conversion characteristic information G(i, j) corresponding to each pixel value R(i, j). The graph in the center of FIG. 4 conceptually illustrates an exemplary gray-scale conversion characteristic, in which the abscissa denotes the pixel value R(i, j) of the reference image data, and the ordinate denotes a value of the gray-scale conversion characteristic information G(i, j).

The gray-scale conversion characteristic may be set such that a value of gray-scale conversion characteristic information G(i, j) tends to decrease as the pixel value R(i, j) of the reference image data increases. That is, a high value of gray-scale conversion characteristic information G(i, j) is derived for a low (dark) pixel value R(i, j), and a low value of gray-scale conversion characteristic information G(i, j) is derived for a high (bright) pixel value R(i, j). For example, the derived gray-scale conversion characteristic may be a so-called reversed-S characteristic as illustrated in the graph in the center of FIG. 4. Alternatively, the gray-scale conversion characteristic information G(i, j) may linearly decrease as the pixel value R(i, j) increases or may decrease in a concave or convex curve shape. Naturally, the gray-scale conversion characteristic may be variously set depending on a purpose of the image or a photographic shooting situation.

According to the present embodiment, the value of the gray-scale conversion characteristic information G(i, j) is an amplification factor (magnification) of the pixel value before and after the gray-scale conversion. For example, as described above, in a case where exposure bracketing is performed five times at 1 Ev in the exposure correction step, exposure is performed at a amplification factor of ×1 (+0 Ev) to ×16 (+4 Ev) for the input image data 1 to input image data n with respect to the minimum amount of exposure (amount of exposure of the input image data 1). The value of the gray-scale conversion characteristic information G(i, j) is preferably set according to a ratio range of the amount of exposure of ×1 to ×16. That is, the amplification factor G(i, j) is preferably set to a value equal to or greater than 1 and equal to or smaller than 16 (or a slightly wider range than that). As a result, the pixel value of the amplification factor G(i, j) can be generated from a pixel value of the original image with an amount of exposure close to G(i, j) times that of the reference image. In addition, in a case where the amplification factor G(i, j) is smaller than the threshold value TH₁, the value of G(i, j) is reset by clipping to G(i, j)=TH₁. In a case where the amplification factor G(i, j) is greater than the threshold value THₙ, the value of G(i, j) may be clipped to G(i, j)=THₙ and be reset.

The threshold values and the number thereof are set based on the exposure correction step and the number of exposure (number of input image data) of exposure bracketing such that appropriate original images W₁, . . . , and Wₙ are selected based on a comparison result between the value of the derived gray-scale conversion characteristic information G(i, j) and the threshold values. According to the present embodiment, the number of threshold values is equal to the number of input image data. The threshold value THₖ (where, integer k=1 to n) means a ratio (Ep(k)/Ep(1)) between the reference image R and the amount of exposure of each non-reference image Uₖ. As a result, in a case where a large amplification factor, that is, a relatively large value of the gray-scale conversion characteristic information G(i, j) is set for a certain pixel, an original image W₁, . . . , and Wₙ of a relatively large amount of exposure is selected. In addition, in a case where a relatively small value of gray-scale conversion characteristic information G(i, j) is set, an original image W₁, . . . , and Wₙ of a small amount of exposure is selected.

According to the gray-scale conversion characteristic described above, the value of G(i, j) decreases as R(i, j) increases, and the value of gray-scale conversion characteristic information G(i, j) is set to the amplification factor, so that a pixel value of the synthesized image data can be set as described below. That is, in the reference image R, a relatively high amplification factor is set for a relatively dark pixel. Accordingly, an original image W₁, . . . , and Wₙ (reference image R and position alignment images Q₂, . . . , and Qₙ) having a relatively large amount of exposure is selected for a relatively dark pixel. As a result, it is possible to increase a gray scale in a shadow portion of an object and reduce noise influence. In contrast, a relatively small amplification factor is set for a relatively bright pixel in the image of the reference image data. Accordingly, an original image W₁, . . . , and Wₙ having a relatively small amount of exposure is selected for a relatively bright pixel. As a result, it is possible to increase a gray scale in a highlight portion of the object. In this manner, it is possible to reproduce a gray scale for a luminance range wider than that of the object. In addition, it is possible to also reduce noise in a shadow portion. In this case, since the value of the gray-scale conversion characteristic information G(i, j) is treated as the amplification factor, it is possible to facilitate matching with the exposure correction step in the exposure bracketing and thus simplify the gray-scale conversion processing of the image data.

In the embodiment of the present invention, during the image synthesis processing, the pixel values of the synthesized image S are generated for each pixel position (i, j) using pixel values of a single or a plurality of images out of the original images W₁, . . . , and Wₙ generated from a plurality of input image data 1 to input image data n obtained through a series of exposure bracketing processes. If each pixel value of the synthesized image S is generated in this manner, it is possible to obtain a synthesized image just like that subjected to gray-scale conversion. For this reason, a representation “gray-scale conversion characteristic” is employed herein.

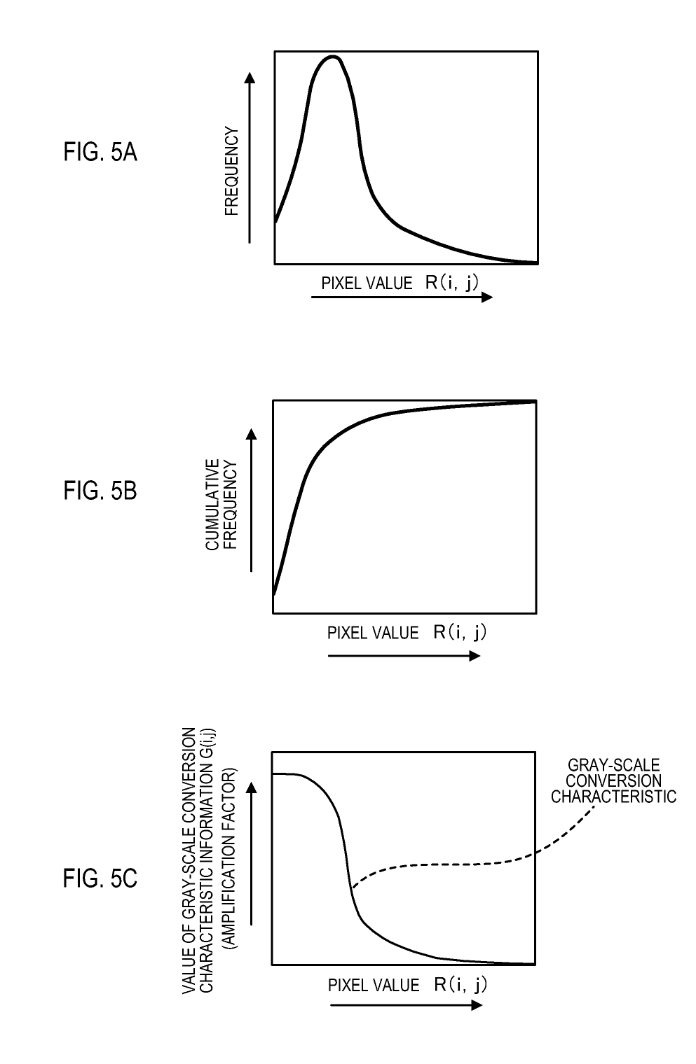

Here, an exemplary method of deriving the gray-scale conversion characteristic using the gray-scale conversion characteristic deriving unit 310 will be described. FIG. 5A is an exemplary histogram of the reference image data. In the example of FIG. 5A, it is assumed that image data obtained from a relatively small amount of exposure is set to the reference image data. As a result, the histogram is biased to a smaller pixel-value side as a whole.

FIG. 5B illustrates cumulative frequency obtained by analyzing the image data illustrated in the histogram of FIG. 5A. A cumulative frequency curve of FIG. 5B has a convex curve shape that abruptly rises in an area of lower pixel values and approaches its limitation in an area of higher pixel values from the center. FIG. 5C illustrates an exemplary gray-scale conversion characteristic derived based on the cumulative frequency curve of FIG. 5B. The curve of FIG. 5C is derived based on an inclination of the cumulative frequency curve of FIG. 5B. That is, the curve of FIG. 5C is obtained by differentiating the cumulative frequency characteristic of FIG. 5B with a pixel value.

The gray-scale conversion characteristic information G(i, j) corresponding to each pixel value R(i, j) of the reference image data is derived based on the gray-scale conversion characteristic of FIG. 5C. In the example of FIG. 5C, the following characteristic is obtained. That is, in the example of FIG. 5C, the gray-scale conversion characteristic has a reversed-S curve shape. As a result, relatively high gray-scale conversion characteristic information G(i, j) is derived for a relatively low pixel value R(i, j), and relatively low gray-scale conversion characteristic information G(i, j) is derived for a relatively high pixel value R(i, j). In addition, in the intermediate range of the pixel value R(i, j), the gray-scale conversion characteristic information G(i, j) remarkably decreases even for an insignificant increase of the pixel value R(i, j). As a result, if the gray-scale conversion characteristic of FIG. 5C is applied, for a pixel having a relatively low pixel value in the reference image data, a pixel value S(i, j) of the synthesized image S is generated from the pixel value of the original image W₁, . . . , and Wₙ having a relatively large amount of exposure. In addition, for a pixel having a relatively high pixel value in the reference image data, a pixel value S(i, j) of the synthesized image S is generated from the pixel value of the original images W₁, . . . , and Wₙ having a relatively small amount of exposure. In the image obtained in this manner, noise is reduced in a low luminance portion, and a highlight phenomenon is suppressed in a high luminance portion. In the intermediate range, it is possible to allocate more gray scales and thus improve contrast. Therefore, it is possible to obtain a distinguishable view.

The method of deriving the gray-scale conversion characteristic described in conjunction with FIGS. 5A to 5C is just exemplary, and the gray-scale conversion characteristic may be derived based on other methods.

The following method may be performed in the process of deriving the gray-scale conversion characteristic information G(i, j) described above. For example, a single gray-scale conversion characteristic may be derived for a single image based on the method described in conjunction with FIGS. 5A to 5C by analyzing the pixel values R(i, j) of overall reference image data. In this case, a single gray-scale conversion characteristic illustrated in FIG. 5C is derived for a single image. Alternatively, as described below, the gray-scale conversion characteristic may be derived in a space-variant manner.

For example, in the gray-scale conversion characteristic deriving unit 310, an image formed using the reference image data is divided into an arbitrary number of blocks in a grid shape along intersecting vertical and horizontal axes to establish a plurality of blocks. In the gray-scale conversion characteristic deriving unit 310, the processing described in conjunction with FIGS. 5A to 5C is performed for each of the established blocks to derive the gray-scale conversion characteristic corresponding to each block. Alternatively, in addition to the simple geometrical dividing method described above, the gray-scale conversion characteristic deriving unit 310 may employ an image processing technique such as object recognition as well in order to establish a plurality of blocks. In this case, an area where it is estimated that a main object exists may be established as a single area. For example, other areas may be divided based on a priority level set depending on brightness or a distance from the area where the main object exists. The gray-scale conversion characteristic deriving unit 310 can derive the gray-scale conversion characteristic information G(i, j) depending on the pixel values of pixels existing in each block using the gray-scale conversion characteristic derived for each block as described above.

In a case where the image processing unit 300 is integrated into a digital camera 100, the area for deriving the gray-scale conversion characteristic may be established by manipulating a touch panel and selecting a main object and the like while a user sees a live-view image displayed on the display unit 150. Alternatively, in a case where the image processing unit 300 is implemented using a computer 200, the area for deriving the gray-scale conversion characteristic may be set by manipulating a computer mouse and the like while a user sees an image displayed on the display unit 280. Using the gray-scale conversion characteristic derived for each area divided based on any one of the methods described above, it is possible to derive the gray-scale conversion characteristic information G(i, j) for the pixel value R(i, j) in each area of the reference image data in a space-variant manner.

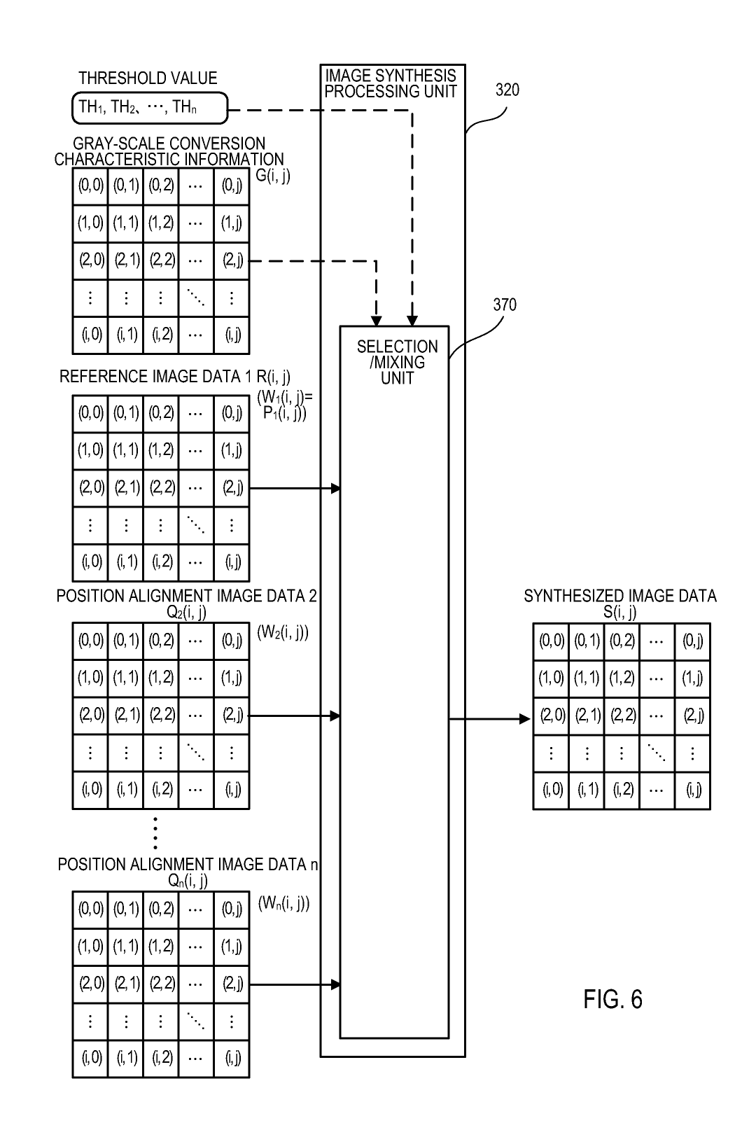

FIG. 6 is a block diagram illustrating main parts of the image synthesis processing unit 320. The image synthesis processing unit 320 has a selection/mixing unit 370. The selection/mixing unit 370 compares the value of the input gray-scale conversion characteristic information G(i, j) and threshold values TH₁, TH₂, . . . , and THₙ for each pixel position (i, j). Based on the comparison result, the selection/mixing unit 370 may select the pixel values W₁(i, j), W₂(i, j), . . . , and Wₙ(i, j) in the corresponding pixel position (i, j) of the original images W₁, . . . , and Wₙ A plurality of the selected pixel values may be mixed through weighted averaging (weighted summing) to obtain each pixel value S(i, j) of the synthesized image data S.

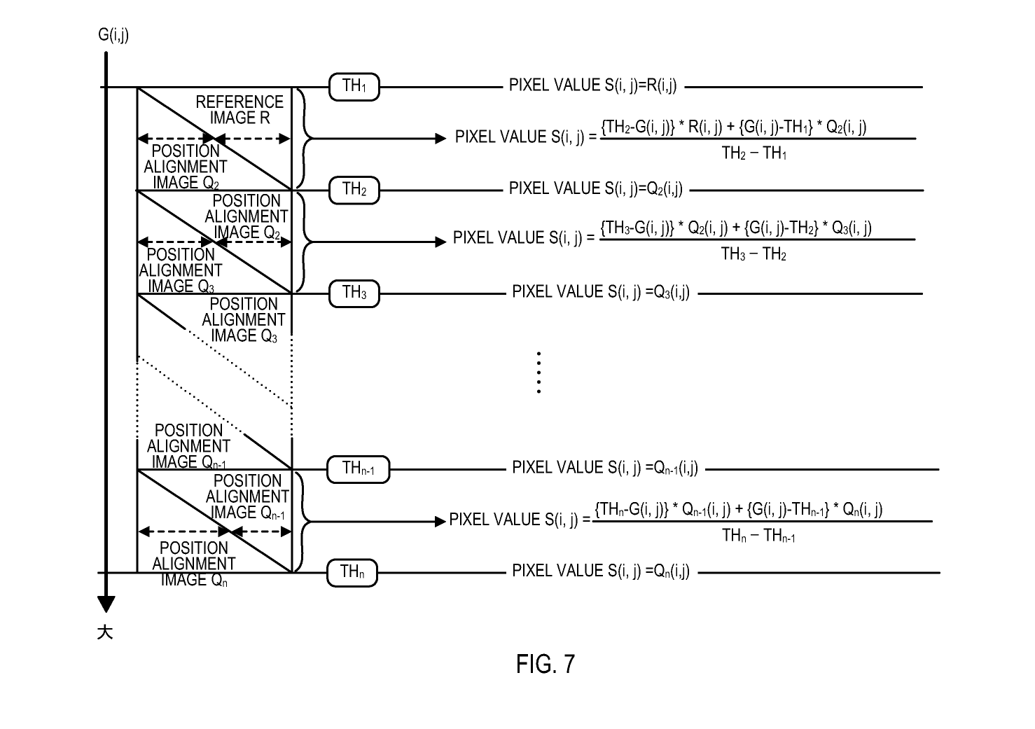

FIG. 7 is a diagram conceptually illustrating a process of mixing a pair of pixel values out of a pair of original images W₁, . . . , and Wₙ selected by the selection/mixing unit 380. In FIG. 7, the threshold values TH₁ to THₙ are set depending on the number of exposure and the exposure correction step at the time of exposure bracketing. In this case, the value of the gray-scale conversion characteristic information G(i, j) may be smaller than the threshold value TH₁ or may be greater than the threshold value THₙ. In a case where the value of the gray-scale conversion characteristic information G(i, j) is smaller than the threshold value TH₁, each pixel value S(i, j) of the synthesized image S is obtained from the value of the gray-scale conversion characteristic information G(i, j) and the pixel value R(i, j) of the reference image. In addition, in a case where the value of the gray-scale conversion characteristic information G(i, j) is greater than the threshold value THₙ, the pixel value S(i, j) is obtained from the pixel value Qₙ(i, j) of the position alignment image, the value of the gray-scale conversion characteristic information G(i, j), and a pair of threshold values TH₁ and THₙ. In FIG. 7, the value of the gray-scale conversion characteristic information G(i, j) increases toward the bottom of FIG. 7. In equations of FIG. 7, a reference symbol * denotes multiplication (the same applies hereinafter).

In a case where the value of the gray-scale conversion characteristic information G(i, j) is smaller than the threshold value TH₁, the reference image R (original image W₁) is selected and corrected. For example, the pixel value S(i, j) of the synthesized image S may be derived based on the following Equation (2).

$$\begin{matrix}[ Equation 2 ] & \\ PIXEL VALUE S ( i , j ) = G ( i , j ) * R ( i , j ) & ( 2 )\end{matrix}$$

In a case where the value of the gray-scale conversion characteristic information G(i, j) is smaller than the threshold value TH₁, the pixel value is derived using Equation (2). Therefore, as the value of the gray-scale conversion characteristic information G(i, j) decreases below the threshold value TH₁, the pixel value S(i, j) also decreases. As a result, it is possible to widen a reproducible gray-scale range in a dark portion in an image. In addition, in a case where the pixel value S(i, j) is derived based on Equation (2), the threshold value TH₁ may preferably be set to TH₁=1. This is because continuity of the pixel value S(i, j) is obtained when the value of the gray-scale conversion characteristic information G(i, j) changes in the vicinity of “1,” so that it is possible to suppress a tone jump.

In a case where the value of the gray-scale conversion characteristic information G(i, j) is equal to or greater than the threshold value TH₁ and equal to or smaller than the threshold value TH₂, the reference image R (original image W₁) and the position alignment image Q₂ (original image W₂) are selected. The pixel values R(i, j) and Q₂(i, j) corresponding to a predetermined pixel position (i, j) out of the reference image R and the position alignment image Q₂ are mixed using the following Equation (3) regarding weighted averaging to derive the pixel value S(i, j) of the pixel position (i, j) corresponding to the mixed synthesized image S.

$$\begin{matrix} [ Equation 3 ] & \\ PIXEL VALUE S ( i , j ) = \frac{[ {TH}_{2} - G ( i , j ) ] * R ( i , j ) + \{ G ( i , j ) - {TH}_{1} \} * {Q}_{2} ( i , j )}{{TH}_{2} - {TH}_{1}} & ( 3 )\end{matrix}$$

As apparent from Equation (3), as the value of the gray-scale conversion characteristic information G(i, j) approaches the threshold value TH₁, the mixing ratio of the pixel value R(i, j) of the reference image R increases. The mixing ratio corresponds to a weight in the weighted averaging (weighted summing). In addition, when the value of the gray-scale conversion characteristic information G(i, j) is equal to the threshold value TH₁, the mixing ratio of the pixel value R(i, j) of the reference image R becomes 100%, and the pixel value S(i, j) becomes equal to the pixel value R(i, j). In contrast, as the value of the gray-scale conversion characteristic information G(i, j) approaches the threshold value TH₂, the mixing ratio of the pixel value Q₂(i, j) of the position alignment image Q₂ increases. In addition, when the value of the gray-scale conversion characteristic information G(i, j) is equal to the threshold value TH₂, the mixing ratio of the pixel value Q₂(i, j) of the position alignment image Q₂ becomes 100%, and the pixel value S(i, j) becomes equal to the pixel value Q₂(i, j). A change of the mixing ratio of the pixel values R(i, j) and Q₂(i, j) is illustrated in FIG. 7 as an inclined solid line. In addition, in both the left and right sides interposing the inclined line, dotted-line arrows are illustrated in both ends. These arrows indicate a mixing ratio of the pixel values R(i, j) and Q₂(i, j) of the position alignment image Q₂ and the reference image R corresponding to a predetermined value of the gray-scale conversion characteristic information G(i, j).

In a case where the value of the gray-scale conversion characteristic information G(i, j) exceeds the threshold value TH₂ and is equal to or smaller than the threshold value TH₃, the position alignment images Q₂ and Q₃ are selected. The pixel values Q₂(i, j) and Q₃(i, j) corresponding to a predetermined pixel position (i, j) of the position alignment images Q₂ and Q₃ are mixed using the following Equation (4) regarding weighted averaging to derive the pixel value S(i, j) in the corresponding pixel position (i, j) of the synthesized image S.

$$\begin{matrix} [ Equation 4 ] & \\ PIXEL VALUE S ( i , j ) = \frac{\{ {TH}_{3} - G ( i , j ) \} * {Q}_{2} ( i , j ) + \{ G ( i , j ) - {TH}_{2} \} * {Q}_{3} ( i , j )}{{TH}_{3} - {TH}_{2}} & ( 4 )\end{matrix}$$

As apparent from Equation (4), as the value of the gray-scale conversion characteristic information G(i, j) approaches the threshold value TH₂, the mixing ratio (weight) of the pixel value Q₂(i, j) of the position alignment image Q₂ increases. In addition, when the value of the gray-scale conversion characteristic information G(i, j) infinitely approaches the threshold value TH₂, the mixing ratio of the pixel value Q₂(i, j) of the position alignment image Q₂ approaches 100%, and the pixel value S(i, j) becomes infinitely equal to the pixel value Q₂(i, j). In contrast, as the value of the gray-scale conversion characteristic information G(i, j) approaches the threshold value TH₃, the mixing ratio of the pixel value Q₃(i, j) of the position alignment image Q₃ increases. In addition, when the value of the gray-scale conversion characteristic information G(i, j) is equal to the threshold value TH₃, the mixing ratio of the pixel value Q₃(i, j) of the position alignment image Q₃ becomes 100%, and the pixel value S(i, j) becomes equal to the pixel value Q₃(i, j).

Similarly, in a case where the value of the gray-scale conversion characteristic information G(i, j) exceeds the threshold value THₙ₋₁ and is equal to or smaller than the threshold value THₙ, the position alignment image Qₙ₋₁ and the position alignment image Qₙ are selected. The pixel values Q₋₁(i, j) and Qₙ(i, j) corresponding to a predetermined pixel position (i, j) of such position alignment images Qₙ₋₁ and Qₙ are mixed using the following Equation (5) regarding weighted averaging to derive the pixel value S(i, j) in the corresponding pixel position (i, j) of the synthesized image S.

$$\begin{matrix} [ Equation 5 ] & \\ PIXEL VALUE S ( i , j ) = \frac{\{ {TH}_{n} - G ( i , j ) \} * {Q}_{n - 1} ( i , j ) + \{ G ( i , j ) - {TH}_{n - 1} \} * {Q}_{n} ( i , j )}{{TH}_{n} - {TH}_{n - 1}} & ( 5 )\end{matrix}$$

As apparent from Equation (5), as the value of the gray-scale conversion characteristic information G(i, j) approaches the threshold value THₙ₋₁, the mixing ratio (weight) of the pixel value Qₙ₋₁(i, j) of the position alignment image Qₙ₋₁ increases. In addition, as the value of the gray-scale conversion characteristic information G(i, j) infinitely approaches the threshold value THₙ₋₁, the mixing ratio of the pixel value Qₙ₋₁(i, j) of the position alignment image Qₙ₋₁ approaches 100%, and the pixel value S(i, j) becomes infinitely equal to the pixel value Qₙ₋₁(i, j). In contrast, as the value of the gray-scale conversion characteristic information G(i, j) approaches the threshold value THₙ, the mixing ratio of the pixel value Qₙ(i, j) of the position alignment image Qₙ increases. In addition, when the value of the gray-scale conversion characteristic information G(i, j) is equal to the threshold value THₙ, the mixing ratio of the pixel value Qₙ(i, j) of the position alignment image Qₙ becomes 100%, and the pixel value S(i, j) becomes equal to the pixel value Qₙ(i, j).

As described above, when the value of the gray-scale conversion characteristic information G(i, j) is equal to the threshold value THₙ, the pixel value S(i, j) of the derived synthesized image S becomes equal to the pixel value Qₙ(i, j) of the position alignment image Qₙ. In addition, when the value of the gray-scale conversion characteristic information G(i, j) is taken from a range between a pair of neighboring threshold values THₙ₋₁ and THₙ, the pixel values Qₙ₋₁(i, j) and Qₙ(i, j) of the position alignment images Qₙ₋₁ and Qₙ are mixed at a mixing ratio derived based on a pair of the threshold values THₙ₋₁ and THₙ and the value of the gray-scale conversion characteristic information G(i, j).

For a general integer k (where, k=3 to n), in a case where the value of the gray-scale conversion characteristic information G(i, j) exceeds the threshold value THₖ₋₁ and is equal to or smaller than the threshold value THₖ, the position alignment images Qₖ₋₁ and Qₖ are selected. The pixel values Qₖ₋₁(i, j) and Qₖ(i, j) corresponding to a predetermined pixel position (i, j) of the position alignment images Qₖ₋₁ and Qₖ are mixed using the following Equation (6) regarding weighted averaging to derive the pixel value S(i, j) of the pixel position (i, j) corresponding to the synthesized image S.

$$\begin{matrix} [ Equation 6 ] & \\ PIXEL VALUE S ( i , j ) = \frac{[ {TH}_{k} - G ( i , j ) ] * {Q}_{k - 1} ( i , j ) + \{ G ( i , j ) - {TH}_{k - 1} \} * {Q}_{k} ( i , j )}{{TH}_{k} - {TH}_{k - 1}} & ( 6 )\end{matrix}$$

In a case where the value of the gray-scale conversion characteristic information G(i, j) exceeds the threshold value THₙ, the position alignment image Qₙ is selected and corrected. For example, the pixel value S(i, j) may be derived based on the following Equation (7).

$$\begin{matrix}[ Equation 7 ] & \\ PIXEL VALUE S ( i , j ) = G ( i , j ) * {Q}_{n} ( i , j ) * \frac{{TH}_{1}}{{TH}_{n}} & ( 7 )\end{matrix}$$

In a case where the gray-scale conversion characteristic information G(i, j) exceeds the threshold value THₙ, the pixel value is derived using Equation (7). Therefore, as the value of the gray-scale conversion characteristic information G(i, j) increases over the threshold value THₙ, the pixel value S(i, j) also increases. As a result, it is possible to widen a reproducible gray-scale range in a bright portion of an image. Even when the pixel value S(i, j) is derived using Equation (7), it is preferable that the threshold value TH₁ be set to “1” for the same reason as that described in conjunction with Equation (2).

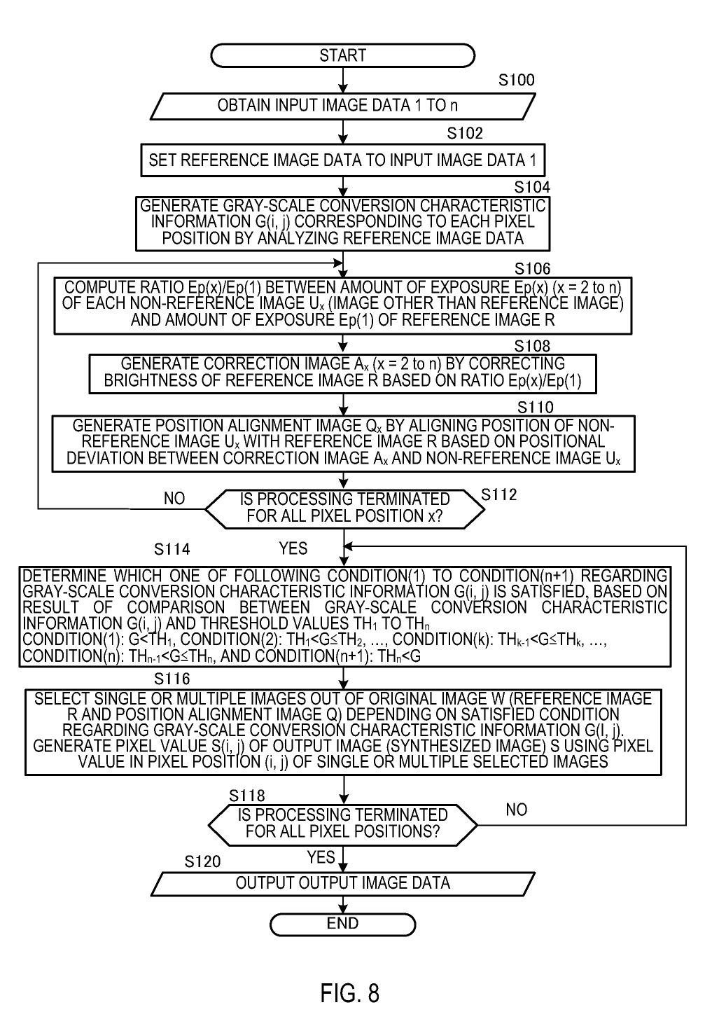

FIG. 8 is a flowchart illustrating a processing sequence of the image synthesis processing executed by the image processing unit 300. In a case where the image processing unit 300 is implemented in the digital camera 100, the processing sequence of FIG. 8 is executed after a series of exposure bracketing processes are performed by the digital camera 100. Alternatively, the processing sequence of FIG. 8 may be executed when a user selects a menu for executing a synthesis processing using the input image data obtained through the exposure bracketing and recorded in the image recording medium 130 in the past. In a case where the image processing unit 300 is implemented by a computer 200, the processing sequence of FIG. 8 is executed when image processing software is executed on a computer 200, and a user selects a menu for executing a synthesis processing using the input image data stored in the subsidiary memory unit 230. The processing sequence of FIG. 8 may be executed by hardware, or software.

In step S100, the image processing unit 300 obtains the input image data 1 to n. In step S102, the image processing unit 300 sets several input image data out of the input image data 1 to n as the reference image data. In the present embodiment, it is assumed that the input image data 1 obtained using the smallest amount of exposure in a series of exposure bracketing processes is set to the reference image data.

In step S104, the image processing unit 300 analyzes the reference image data to create gray-scale conversion characteristic information G(i, j) corresponding to each pixel position (i, j). The gray-scale conversion characteristic information G(i, j) is treated as an amplification factor. Details of the sequence of creating the gray-scale conversion characteristic information G(i, j) are similar to those described above in conjunction with FIGS. 4 and 5A to 5C. Furthermore, the gray-scale conversion characteristic information G(i, j) may be obtained by analyzing pixel values of overall reference image data or may be obtained in a space-variant manner.

In step S106, the image processing unit 300 computes the ratio Ep(x)/Ep(1) between the amount of exposure Ep(1) of the reference image R and the amount of exposure Ep(x) of each non-reference image Uₓ. In step S108, the image processing unit 300 generates a correction image Aₓ (where, x=2 to n) by correcting brightness of the reference image R based on the ratio Ep(x)/Ep(1) as described in conjunction with Equation (1). In step S110, the image processing unit 300 aligns a position of the non-reference image Uₓ with the reference image R based on a positional deviation between the correction image Aₓ and the non-reference image Uₓ to generate a position alignment image Qₓ. In step S112, the image processing unit 300 determines whether or not the position alignment images Qₓ are generated for overall image data x (where, x=2 to n). In a case where the position alignment images Qₓ are not generated for overall image data x, the routine returns to step S106, and steps S106 to S110 are repeated for the next image data x. In a case where the position alignment images Qₓ are generated for overall image data x, the routine advances to step S114.

In step S114, the image processing unit 300 compares values of the gray-scale conversion characteristic information G(i, j) in a predetermined pixel position (i, j) of the gray-scale conversion characteristic information G(i, j) generated in step S104 with the threshold values TH₁ to THₙ. Specifically, the image processing unit 300 determines which one of Condition(1) to Condition(n+1) for the gray-scale conversion characteristic information G(i, j) described below is satisfied.

{Condition(1): G≦TH₁, Condition(2): TH₁<G≦TH₂, . . . Condition(k): THₖ₋₁<G≦THₖ, . . . Condition(n): THₙ₋₁<G≦THₙ, and Condition(n+1): THₙ<G}

In step S116, the image processing unit 300 selects a single or a plurality of images out of the original images W₁, . . . , and Wₙ (reference image R and position alignment image Q₂, . . . , and Qₙ) depending on the satisfied condition regarding the gray-scale conversion characteristic information G(i, j). In addition, the image processing unit 300 generates the pixel value S(i, j) of the output image (synthesized image) S using the pixel value of a single or a plurality of the selected images in the pixel position (i, j). Details of step S116 will be described below.

In step S118, the image processing unit 300 determines whether or not the processing in steps S114 and S116 is performed for overall pixel positions (i, j). If it is determined NO in step S118, steps S114 to S116 are repeatedly processed. Otherwise, if it is determined YES in step S114, the image processing unit 300 performs a process of outputting synthesized image data S in step S120. As a result, the image based on the synthesized image data S is recorded on the image recording unit 360 of FIG. 3. In addition, the image based on the synthesized image data S is displayed on the display unit 350 as necessary.

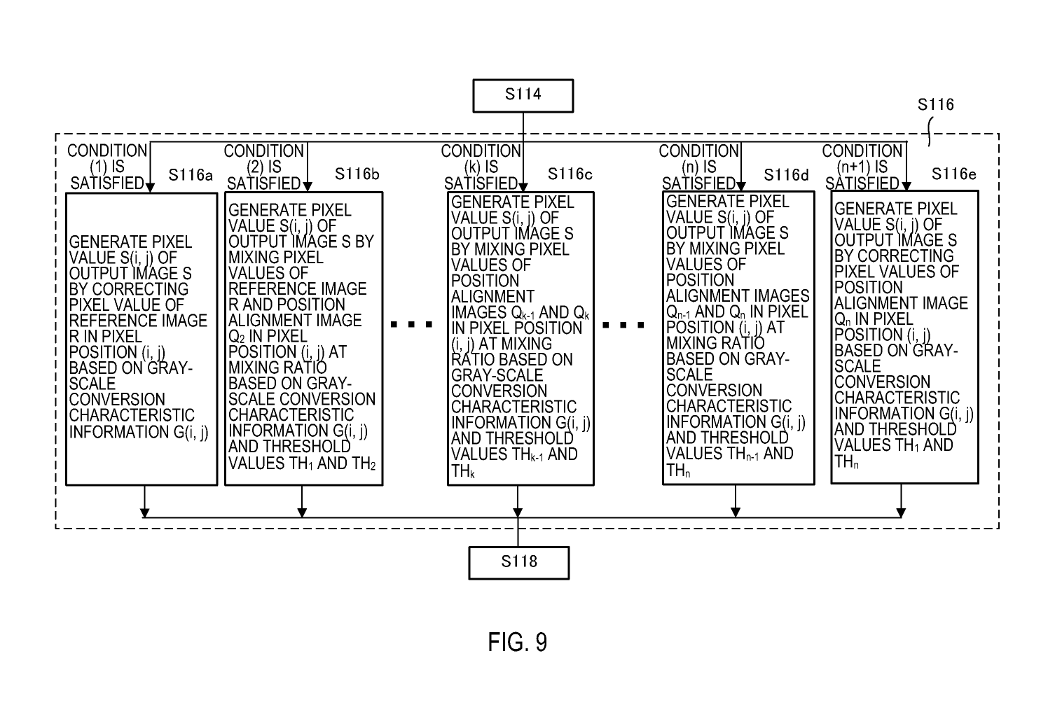

FIG. 9 is a diagram illustrating details of step S116. If Condition(1) is satisfied, in step S116a, the image processing unit 300 generates a pixel value S(i, j) of the output image S by correcting the pixel value of the reference image R in the pixel position (i, j) based on the value of the gray-scale conversion characteristic information G(i, j). That is, the image processing unit 300 performs the computation of Equation (2) described above.

If Condition(2) is satisfied, in step S116b, the image processing unit 300 generates the pixel value S(i, j) of the output image S by mixing pixel values of the reference image R and the position alignment image Q₂ in the pixel position (i, j) at a mixing ratio based on the value of the gray-scale conversion characteristic information G(i, j) and the threshold values TH₁ and TH₂. That is, the image processing unit 300 computes Equation (3) described above.

If Condition(k) (where, k=3 to n) is satisfied, similar to steps S116c and S116d, the image processing unit 300 generate the pixel value S(i, j) of the output image S by mixing pixel values of the position alignment images Qₖ₋₁ and Qₖ in the pixel position (i, j) at a mixing ratio based on the value of the gray-scale conversion characteristic information G(i, j) and the threshold values THₖ₋₁ and THₖ. That is, the image processing unit 300 computes Equation (6) described above.

If Condition(n+1) is satisfied, similar to step S116e, the image processing unit 300 generates the pixel value S(i, j) of the output image S by correcting the pixel value of the position alignment image Qₙ in the pixel position (i, j) based on the value of the gray-scale conversion characteristic information G(i, j) and the threshold values TH₁ and THₙ. That is, the image processing unit 300 computes Equation (7) described above.

(Effects and Advantages)

According to the first embodiment, the gray-scale conversion characteristic deriving unit 310 derives the gray-scale conversion characteristic G from the reference image R selected from a plurality of input images obtained by shooting an identical object with a different amount of exposure. The normalizing unit 410 generates the correction image Aₓ by correcting the brightness of the reference image based on the amount of exposure Ep(x) of the non-reference image Uₓ other than the reference image and the amount of exposure Ep(1) of the reference image. The position alignment processing unit 420 computes a positional deviation between the correction image Aₓ and the non-reference image Uₓ and generates the position alignment image Qₓ by aligning a position of the non-reference image with the reference image based on the positional deviation. The image synthesis processing unit 320 derives a new pixel value for each pixel using the pixel value of a single or a plurality of the selected images out of the reference image R and the position alignment images Qₓ based on the gray-scale conversion characteristic to generate a synthesized image S.

In this manner, the reference image R and the non-reference images Uₓ are set from a plurality of input images obtained with a different amount of exposure. A single or a plurality of images are selected out of the reference image R and the position alignment image Qₓ generated by aligning a position of the non-reference image Uₓ with the reference image R, and a new pixel value is derived for each pixel, so that an HDR image is generated as a synthesized image S. For this reason, it is possible to form a HDR image having a gray-scale conversion characteristic suitable for the scene. In this case, the pixel values R(i, j) and Qₓ(i, j) respectively corresponding to the reference image R and the position alignment image Qₓ represented using a predetermined bit depth are mixed (weighted-averaged) to obtain a corresponding pixel value S(i, j) of the synthesized image S represented using the same bit depth. For this reason, it is possible to perform a process of obtaining the synthesized image S without adding a bit depth. Accordingly, it is possible to perform the synthesis processing within a bit depth range of the synthesized image data finally obtained and thus suppress a hardware size from increasing. In addition, due to the position alignment described above, it is possible to suppress degradation of the synthesized image S caused by a time-dependent positional deviation of the input image.

In this case, if the gray-scale conversion characteristic is derived in a space-variant manner as described above, it is possible to perform an image synthesis processing with a gray-scale conversion characteristic suitable for each area within an image. In addition, the position alignment processing unit 420 may generate a plurality of position alignment images by aligning positions of a plurality of non-reference images with the reference image, and the image synthesis processing unit 320 may derive a new pixel value for each pixel using the pixel values of a single or a plurality of images selected out of a plurality of position alignment images based on the gray-scale conversion characteristic. As a result, it is possible to improve a dynamic range and obtain the synthesized image S with reduced degradation.

The gray-scale conversion characteristic deriving unit 310 derives an amplification factor for each pixel value of the reference image as a gray-scale conversion characteristic G. The image synthesis processing unit 320 selects two or more images out of the reference image and the position alignment image depending on the amplification factor and mixes the pixel values of the two or more selected images at a mixing ratio derived based on the amplification factor to derive a new pixel value. If an image is generated through such a mixing process, it is possible to suppress generation of a so-called artifact. That is, a change of brightness becomes smoother in the image formed from the synthesized image data. Therefore, it is possible to suppress generation of an abnormal phenomenon such as a tone jump in which a gray scale unnaturally changes in an image in which a tone delicately changes as in a human skin.

The image synthesis processing unit 320 sets the threshold value depending on the amount of exposure set when each of a plurality of input images is obtained. The image synthesis processing unit 320 mixes the pixel values of the two or more selected images at a mixing ratio derived based on the amplification factor and the threshold value. As a result, it is possible to further suppress an unnatural change of the gray scale in the image.

### Second Embodiment

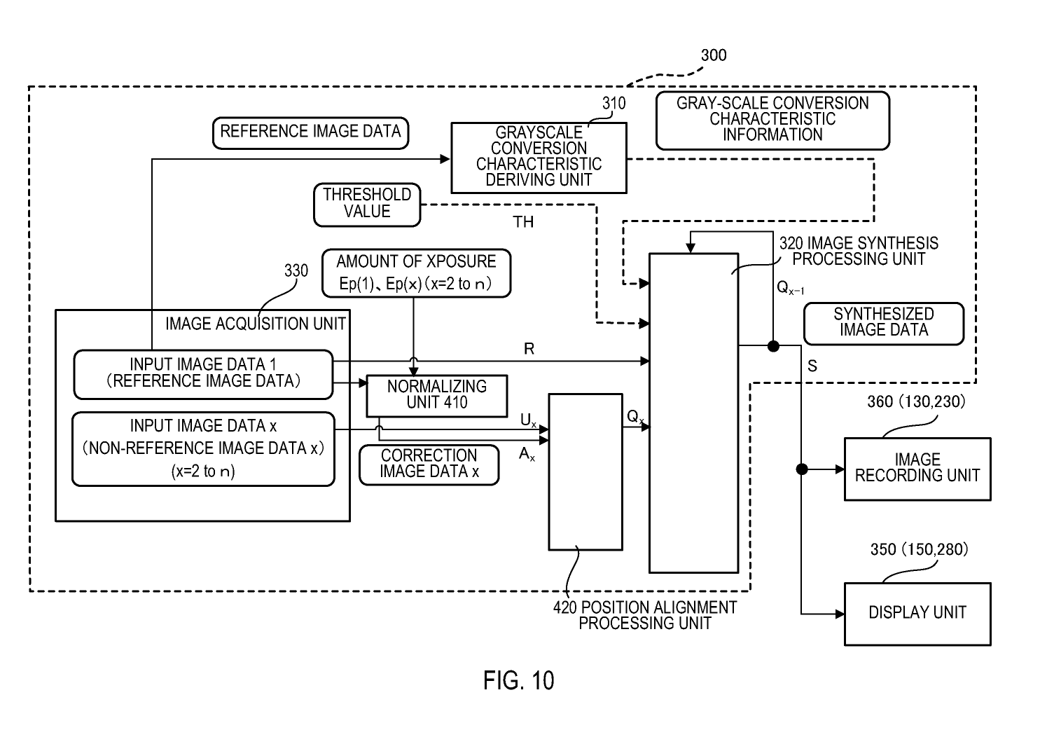

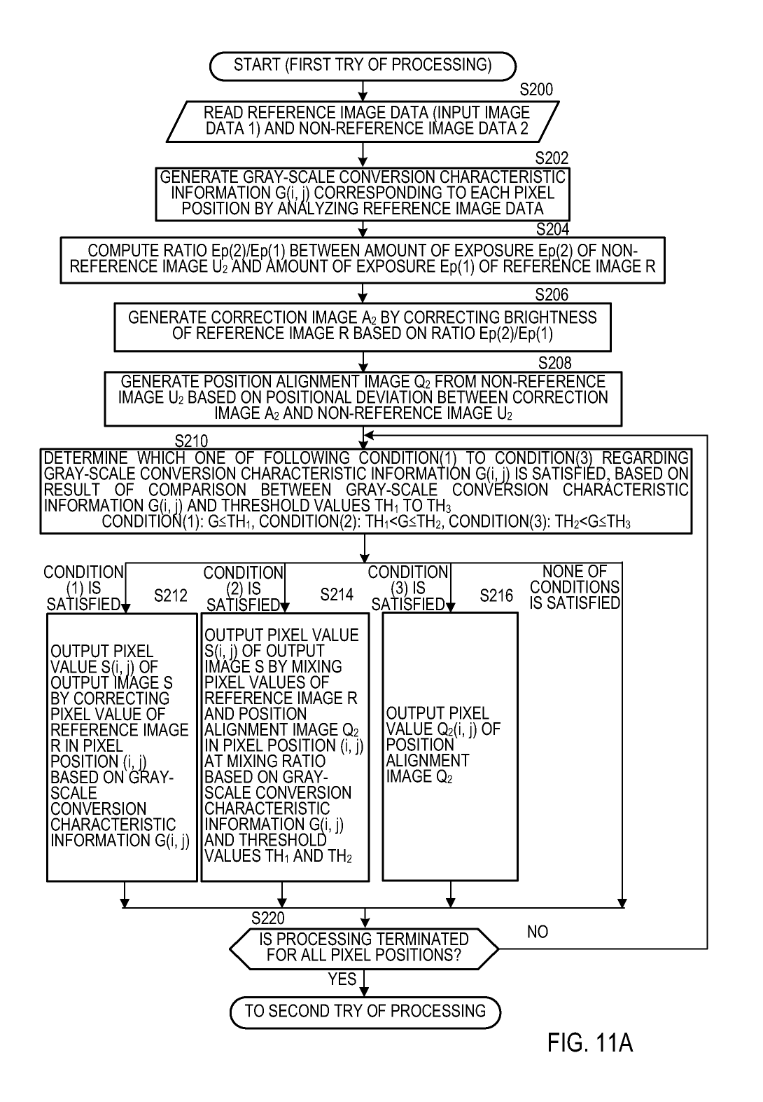

FIG. 10 is a block diagram schematically illustrating a configuration of the image processing unit 300 according to a second embodiment. In the first embodiment, the image processing unit 300 generates overall position alignment images Q₂, . . . , and Qₙ used by the position alignment processing unit 420 in the image synthesis, and the image synthesis processing unit 320 then performs image synthesis. However, a memory area for storing the position alignment image may remarkably increase. In this regard, according to the second embodiment, the image synthesis processing unit 320 performs the image synthesis whenever a single position alignment image Qₓ is generated. As a result, it is not necessary to store overall position alignment images Q₂, . . . , and Qₙ in a memory such as the memory unit 160. Therefore, a memory area for storing the position alignment image is reduced. The output of the image synthesis processing unit 320 is fed back to the image synthesis processing unit 320, so that the image processing unit 300 performs a feedback (cyclic) processing.

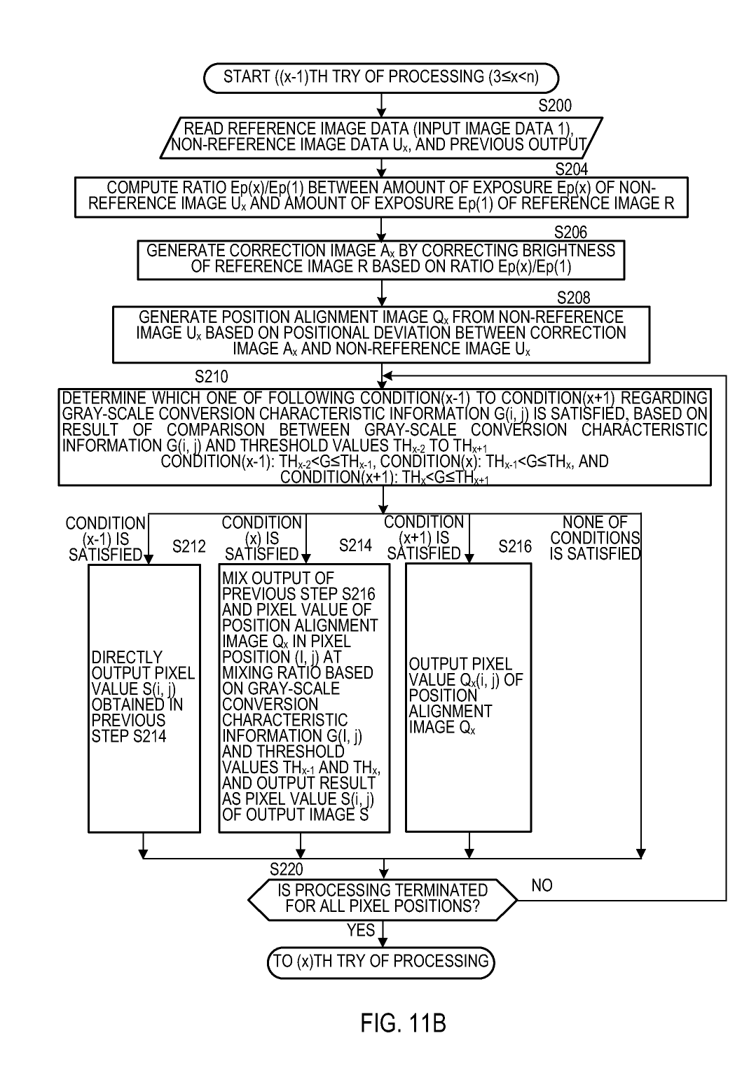

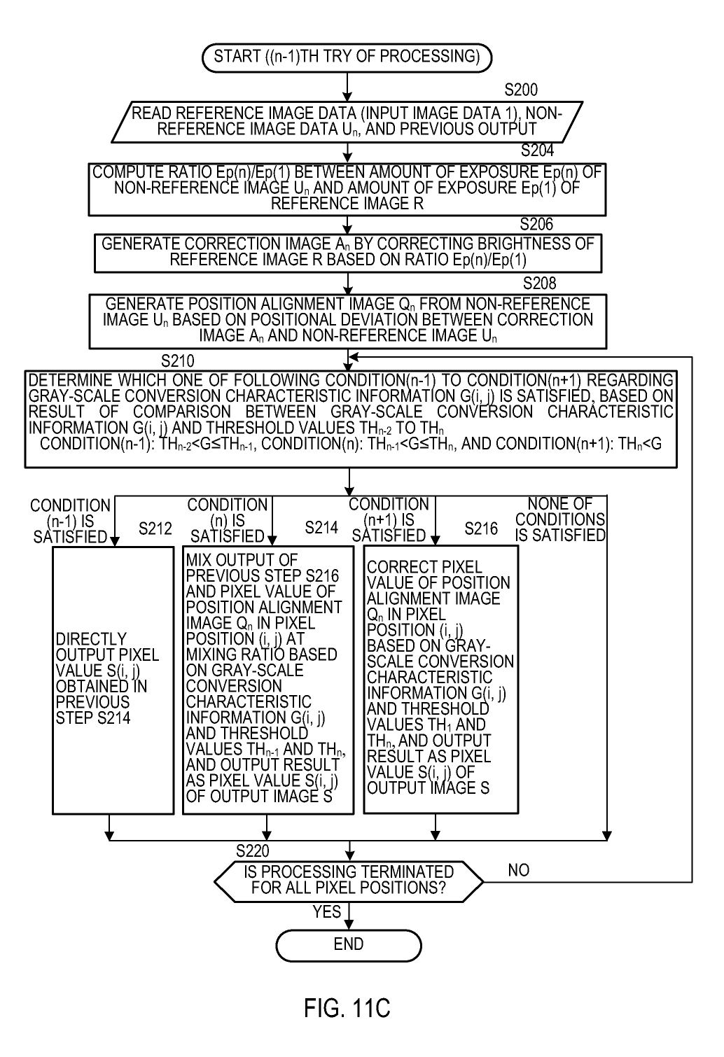

FIGS. 11A to 11C are flowcharts illustrating a processing sequence of the image synthesis processing executed by the image processing unit 300 according to the second embodiment. The image synthesis processing executed by the image processing unit 300 in the first embodiment is dividingly executed in a plurality of tries according to the second embodiment.

FIG. 11A illustrates a process executed by the image processing unit 300 in the first try. In step S200, the image processing unit 300 reads the reference image data (input image data 1) and the non-reference image data 2. In step S202, the image processing unit 300 analyzes the reference image data and generates gray-scale conversion characteristic information G(i, j) corresponding to each pixel position. In step S204, the image processing unit 300 computes a ratio Ep(2)/Ep(1) between the amount of exposure Ep(2) and the amount of exposure Ep(1). In step S206, the image processing unit 300 generate a correction image A₂ by correcting brightness of the reference image R based on the ratio Ep(2)/Ep(1). In step S208, the image processing unit 300 generates a position alignment image Q₂ by performing position alignment between the non-reference image U₂ and the reference image R based on a positional deviation between the correction image A₂ and the non-reference image U₂.

In the first try of step S210, the image processing unit 300 determines whether or not Condition(1) to Condition(3) regarding the gray-scale conversion characteristic information G(i, j) described above are satisfied based on a comparison result between the value of the gray-scale conversion characteristic information G(i, j) and the threshold values TH₁ to TH₃. If Condition(1) is satisfied, in step S212, the image processing unit 300 performs the same processing as that of step S116a to compute Equation (2) described above and outputs the result. If Condition(2) is satisfied, in step S214, the image processing unit 300 performs the same processing as that of step S116b to compute Equation (3) described above and output the result. If Condition(3) is satisfied, in step S216, the image processing unit 300 outputs the pixel value Q₂(i, j) of the position alignment image Q₂. If none of Condition(1) to Condition(3) is satisfied, the routine advances to step S220 without performing anything. In step S220, the image processing unit 300 determines whether or not the processing of step S210 is performed for overall pixel positions (i, j). If it is determined NO in step S220, the routine returns to step S210.

FIG. 11B illustrates the (x−1)th try of the processing performed by the image processing unit 300 for the reference image data x (where, 3≦x<n) after the first try. In step S200, the image processing unit 300 reads the reference image data (input image data 1), the non-reference image data x, and the output of the previous processing. In step S204, the image processing unit 300 computes the ratio Ep(x)/Ep(1) between the amount of exposure Ep(x) and the amount of exposure Ep(1). In step S206, the image processing unit 300 corrects brightness of the reference image R based on the ratio Ep(x)/Ep(1) to generate the correction image A. In step S208, the image processing unit 300 performs position alignment between the non-reference image Uₓ and the reference image R based on a positional deviation between the correction image Aₓ and the non-reference image Uₓ to generate the position alignment image Qₓ.

In the (x−1)th try of step S210, the image processing unit 300 determines whether or not Condition(x−1) to Condition(x+1) regarding the gray-scale conversion characteristic information G(i, j) described above are satisfied based on the comparison result between the value of the gray-scale conversion characteristic information G(i, j) and the threshold values THₓ₋₂ to THₓ₊₁. If Condition(x−1) is satisfied, in step S212, the image processing unit 300 directly outputs the pixel value S(i, j) obtained in the previous try of step S214. If Condition(x) is satisfied, the routine advances to step S214. In step S214, the image processing unit 300 mixes the output (Qₓ₋₁) of the previous try of step S216 and the pixel value of the position alignment image Qₓ at a mixing ratio based on the value of the gray-scale conversion characteristic information G(i, j) and the threshold values THₓ₋₁ and THₓ as described in the following Equation (8), and outputs the result as a pixel value S(i, j) of the output image S.

$$\begin{matrix} [ Equation 8 ] & \\ PIXEL VALUE S ( i , j ) = \frac{\{ {TH}_{x} - G ( i , j ) \} * {Q}_{x - 1} ( i , j ) + \{ G ( i , j ) - {TH}_{x - 1} \} * {Q}_{x} ( i , j )}{{TH}_{x} - {TH}_{x - 1}} & ( 8 )\end{matrix}$$

If Condition(x+1) is satisfied, in step S216, the image processing unit 300 outputs the pixel value Qₓ(i, j) of the position alignment image Qₓ. If none of Condition(x−1) to Condition(x+1) is satisfied, the routine advances to step S220 without performing anything.

FIG. 11C illustrates the processing performed by the image processing unit 300 in the (n−1)th try. The image processing unit 300 performs the (x−1)th try of the processing of steps S200 to S214 by setting x=n as described above. However, if Condition(n+1) is satisfied in step S210, in step S216, the image processing unit 300 performs the same processing as that of step S116e to compute Equation (7) described above and output the result.

According to the second embodiment, the image processing unit 300 dividingly executes the image synthesis processing in a plurality of tries. For this reason, a processing scale is reduced, and it is possible to reduce a memory capacity such as the memory unit 160.

### Third Embodiment

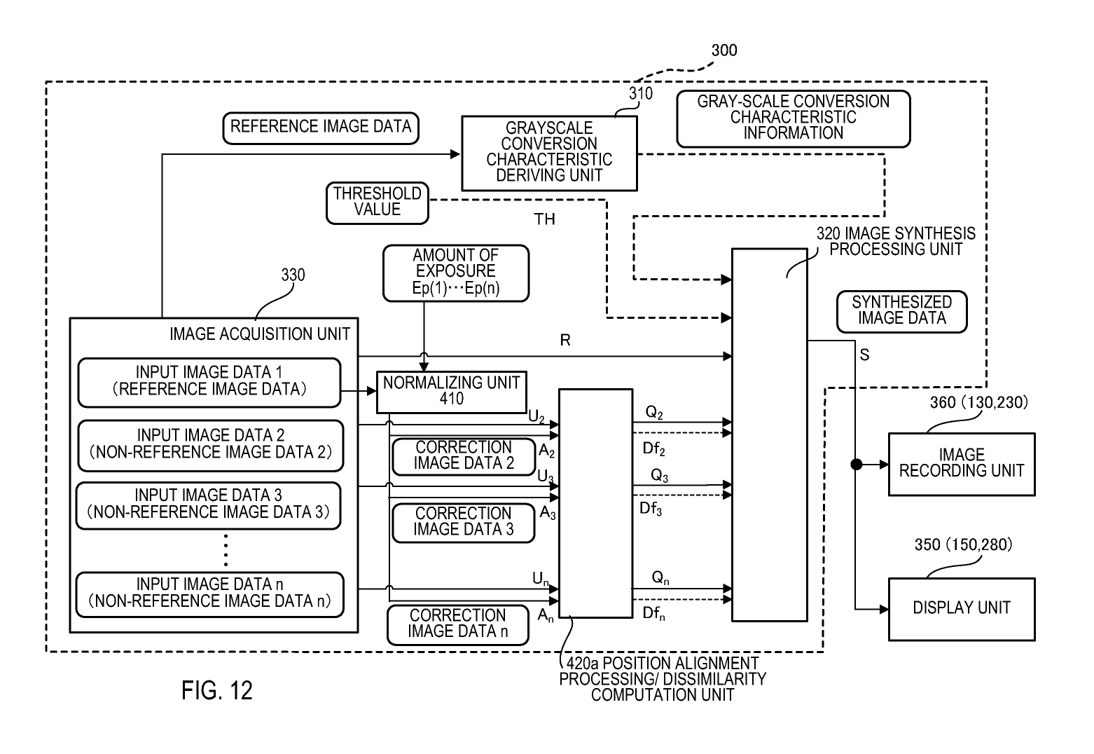

FIG. 12 is a block diagram schematically illustrating a configuration of the image processing unit 300 according to a third embodiment. In the third embodiment, a position alignment/dissimilarity computation unit 420a generates position alignment images Qₓ (where, x=2 to n) and computes a dissimilarity between the correction image Aₓ and the position alignment image Qₓ and inputs the result to the image synthesis processing unit 320. The dissimilarity Dfₓ indicates a positional deviation degree of the position alignment image Qₓ against the correction image Aₓ in a direct meaning. In an indirect meaning, the dissimilarity Dfₓ also indicates a positional deviation degree of the position alignment image Qₓ against the reference image R.

For example, the position alignment/dissimilarity computation unit 420a sets a neighboring pixel area (3×3) with respect to the coordinates (i, j) and computes a sum of absolute differences SAD as the dissimilarity Dfₓ between the correction image Aₓ and the position alignment image Qₓ in the corresponding area based on the following Equation (9).

$$\begin{matrix} [ Equation 9 ] & \\ {Df}_{x} ( i , j ) = \vert {A}_{x} ( i - 1 , j - 1 ) - {Q}_{x} ( i - 1 , j - 1 ) \vert + \vert {A}_{x} ( i - 1 , j ) - {Q}_{x} ( i - 1 , j ) \vert + \vert {A}_{x} ( i - 1 , j + 1 ) - {Q}_{x} ( i - 1 , j + 1 ) \vert + \vert {A}_{x} ( i , j - 1 ) - {Q}_{x} ( i , j - 1 ) \vert + \vert {A}_{x} ( i , j ) - {Q}_{x} ( i , j ) \vert + \vert {A}_{x} ( i , j + 1 ) - {Q}_{x} ( i , j + 1 ) \vert + \vert {A}_{x} ( i + 1 , j - 1 ) - {Q}_{x} ( i + 1 , j - 1 ) \vert + \vert {A}_{x} ( i + 1 , j ) - {Q}_{x} ( i + 1 , j ) \vert + \vert {A}_{x} ( i + 1 , j + 1 ) - {Q}_{x} ( i + 1 , j + 1 ) \vert & ( 9 )\end{matrix}$$

The image synthesis processing unit 320 selects a single or a plurality of images from the reference image R, the position alignment images Q₂, . . . , and Qₙ, and the correction images A₂, . . . , and Aₙ based on the value of the gray-scale conversion characteristic information G(i, j) and the threshold values TH₁ to THₙ and generates the synthesized image S by correcting the selected images or performing weighted-averaging. For example, in a case where the value of the gray-scale conversion characteristic information G(i, j) is between a pair of threshold values THₖ₋₁ and THₖ (k>2), the image synthesis processing unit 320 generates the synthesized image S by selecting four images (a pair of position alignment images Qₖ₋₁ and Qₖ and a pair of correction images Aₖ₋₁ and Aₖ) and synthesizing the selected images based on the value of the gray-scale conversion characteristic information G(i, j), a pair of threshold values THₖ₋₁ and THₖ, and a pair of dissimilarities Dfₖ₋₁ and Dfₖ.

In a case where the value of the gray-scale conversion characteristic information G(i, j) is equal to or smaller than the threshold value TH₁, the reference image R is selected and corrected. For example, the pixel value S(i, j) of the synthesized image S may be derived based on Equation (2) described above.

In a case where the value of the gray-scale conversion characteristic information G(i, j) is greater than the threshold value TH₁ and is equal to or smaller than the threshold value TH₂, the reference image R, the position alignment image Q₂, and the correction image A₂ are selected. The pixel values R(i, j), Q₂(i, j), and A₂(i, j) corresponding to a predetermined pixel position (i, j) out of the reference image R, the position alignment image Q₂, and the correction image A₂ are mixed using the following Equations (10) and (11). In addition, the pixel value S(i, j) corresponding to the synthesized image S in the pixel position (i, j) is derived.

$$\begin{matrix} [ Equation 10 ] & \\ PIXEL VALUE {B}_{2} ( i , j ) = F ( {Df}_{2} ) * {Q}_{2} ( i , j ) + [ 1 - F ( {Df}_{2} ) ] * {A}_{2} ( i , j ) & ( 10 ) \\ [ Equation 11 ] & \\ PIXEL VALUE S ( i , j ) = \frac{[ {TH}_{2} - G ( i , j ) ] * R ( i , j ) + \{ G ( i , j ) - {TH}_{1} \} * {B}_{2} ( i , j )}{{TH}_{2} - {TH}_{1}} & ( 11 )\end{matrix}$$

As recognized by substituting Equation (10), Equation (11) also expresses the weighted average of the pixel value R(i, j) of the reference image R, the pixel value Q₂(i, j) of the position alignment image Q₂, and the pixel value A₂(i, j) of the correction image A₂.

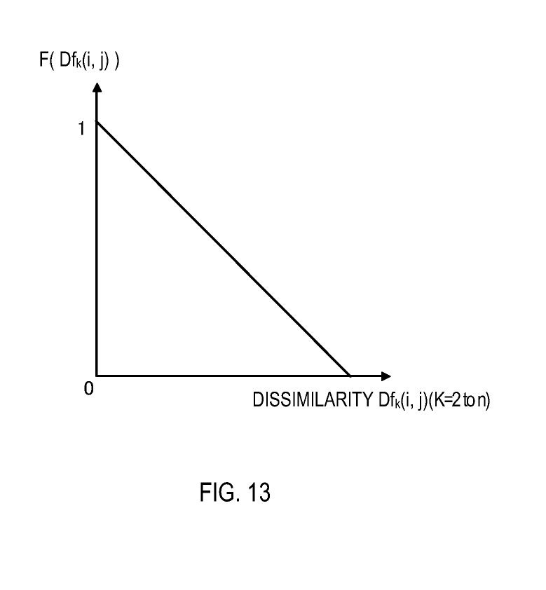

Here, the pixel value B₂(i, j) of the intermediate image B₂ is obtained by weighted-averaging the pixel value Q₂(i, j) of the position alignment image Q₂ and the pixel value A₂(i, j) of the correction image A₂ based on the function F(Df₂). As illustrated in FIG. 13, the function F(Df₂) is a function decreasing in proportion to the dissimilarity Df₂. That is, the function F(Df₂) approaches “0” as the dissimilarity Df₂ increases. The function F(Df₂) approaches “1” as the dissimilarity Df₂ decreases.

As apparent from Equation (11), in the pixel value S(i, j) of the synthesized image S, the mixing ratio of the pixel value R(i, j) of the reference image R increases as the value of the gray-scale conversion characteristic information G(i, j) approaches the threshold value TH₁. In contrast, the mixing ratio of the pixel value B₂(i, j) of the intermediate image B₂ increases as the value of the gray-scale conversion characteristic information G(i, j) approaches the threshold value TH₂. Therefore, in the pixel value S(i, j), the mixing ratio between the pixel value Q₂(i, j) of the position alignment image Q₂ and the pixel value A₂(i, j) of the correction image A₂ increases as the value of the gray-scale conversion characteristic information G(i, j) approaches the threshold value TH₂.

Similarly, for a general integer k (where, k=3 to n) in a case where the value of the gray-scale conversion characteristic information G(i, j) exceeds the threshold value THₖ₋₁ and is equal to or smaller than the threshold value THₖ, four images including the position alignment images Qₖ₋₁ and Qₖ and the correction images Aₖ₋₁ and Aₖ are selected. The pixel values Qₖ₋₁(i, j), Qₖ(i, j), Aₖ₋₁(i, j), and Aₖ(i, j) corresponding to a predetermined pixel position (i, j) of the position alignment images Qₖ₋₁ and Qₖ and the correction images Aₖ₋₁ and Aₖ are mixed using the following Equations (12), (13), and (14). In addition, the pixel value S(i, j) of the pixel position (i, j) corresponding to the synthesized image S is derived.

$$\begin{matrix} [ Equation 12 ] & \\ PIXEL VALUE {B}_{k - 1} ( i , j ) = F ( {Df}_{k - 1} ) * {Q}_{k - 1} ( i , j ) + [ 1 - F ( {Df}_{k - 1} ) ] * {A}_{k - 1} ( i , j ) & ( 12 ) \\ [ Equation 13 ] & \\ PIXEL VALUE {B}_{k} ( i , j ) = F ( {Df}_{k} ) * {Q}_{k} ( i , j ) + [ 1 - F ( {Df}_{k} ) ] * {A}_{k} ( i , j ) & ( 13 ) \\ [ Equation 14 ] & \\ S ( i , j ) = \frac{\{ {TH}_{k} - G ( i , j ) \} * {B}_{k - 1} ( i , j ) + \{ G ( i , j ) - {TH}_{k - 1} \} * {B}_{k} ( i , j )}{{TH}_{k} - {TH}_{k - 1}} & ( 14 )\end{matrix}$$

Equation (14) changes to Equation (15) by substituting Equations (12) and (13). As recognized from Equation (15), the weighted average of the pixel value Qₖ₋₁(i, j) of the position alignment image Qₖ₋₁, the pixel value Qₖ(i, j) of the position alignment image Qₖ, the pixel value Aₖ₋₁(i, j) of the correction image Aₖ₋₁, and the pixel value Aₖ(i, j) of the correction image Aₖ is also expressed.

$$\begin{matrix} [ Equation 15 ] & \\ S ( i , j ) = \frac{\begin{matrix}\{ {TH}_{k} - G ( i , j ) \} * F ( {Df}_{k - 1} ) * {Q}_{k - 1} ( i , j ) + \\ \{ {TH}_{k} - G ( i , j ) \} * \{ 1 - F ( {Df}_{k - 1} ) \} * {A}_{k - 1} ( i , j )\end{matrix}}{{TH}_{k} - {TH}_{k - 1}} + \frac{\begin{matrix}\{ G ( i , j ) - {TH}_{k - 1} \} * F ( {Df}_{k} ) * {Q}_{k} ( i , j ) + \\ \{ G ( i , j ) - {TH}_{k - 1} \} * \{ 1 - F ( {Df}_{k} ) \} * {A}_{k} ( i , j )\end{matrix}}{{TH}_{k} - {TH}_{k - 1}} & ( 15 )\end{matrix}$$

Here, the pixel value Bₖ(i, j) of the intermediate image Bₖ is obtained by weighted-averaging the pixel value Qₖ(i, j) of the position alignment image Qₖ and the pixel value Aₖ(i, j) of the correction image Aₖ according to the function F(Dfₖ). As illustrated in FIG. 13, the function F(Dfₖ) (where, k=2 to n) decreases in proportion to the dissimilarity Dfₖ. The function F(Dfₖ) approaches “0” as the dissimilarity Dfₖ increases. The function F(Dfₖ) approaches “1” as the dissimilarity decreases. Based on such a function F, for the synthesized image S, the mixing ratio (weight) of the position alignment image increases as the dissimilarity decreases. The mixing ratio (weight) of the position alignment image decreases as the dissimilarity increases. As a result, in generation of the pixel value S(i, j) of the synthesized image S, it is possible to reduce a contribution of the pixel value of the position alignment image having a high dissimilarity. Therefore, it is possible to prevent degradation of the synthesized image S caused by a positional deviation.

As apparent from Equation (14), in the pixel value S(i, j) of the synthesized image S, the mixing ratio of the pixel value Bₖ₋₁(i, j) of the intermediate image Bₖ₋₁ increases as the value of the gray-scale conversion characteristic information G(i, j) approaches the threshold value THₖ₋₁. Therefore, as the value of the gray-scale conversion characteristic information G(i, j) approaches the threshold value THₖ₋₁, the mixing ratio of the pixel value Qₖ₋₁(i, j) of the position alignment image Qₖ₋₁ and the pixel value Aₖ₋₁(i, j) of the correction image Aₖ₋₁ increases. In contrast, as the value of the gray-scale conversion characteristic information G(i, j) approaches the threshold value THₖ, the mixing ratio of the pixel value Bₖ(i, j) of the intermediate image Bₖ increases. Therefore, as the value of the gray-scale conversion characteristic information G(i, j) approaches the threshold value THₖ, the mixing ratio of the pixel value Qₖ(i, j) of the position alignment image Qₖ and the pixel value Aₖ(i, j) of the correction image Aₖ increases.

In a case where the value of the gray-scale conversion characteristic information G(i, j) exceeds the threshold value THₙ, four images including the position alignment images Qₙ₋₁ and Qₙ and the correction images Aₙ₋₁ and Aₙ are selected. From the pixel values Qₙ₋₁(i, j), Qₙ(i, j), Aₙ₋₁(i, j), and Aₙ(i, j) corresponding to a predetermined pixel position (i, j) out of the position alignment images Qₙ₋₁ and Qₙ and the correction images Aₙ₋₁ and Aₙ, for example, the pixel value S(i, j) can be derived based on the following Equation (16).

$$\begin{matrix} [ Equation 16 ] & \\ S ( i , j ) = G ( i , j ) * \{ F ( {Df}_{n} ) * {B}_{n} ( i , j ) * \frac{{TH}_{1}}{{TH}_{n}} + ( 1 - F ( {Df}_{n} ) ) * {B}_{n - 1} ( i , j ) * \frac{{TH}_{1}}{{TH}_{n - 1}} \} & ( 16 )\end{matrix}$$

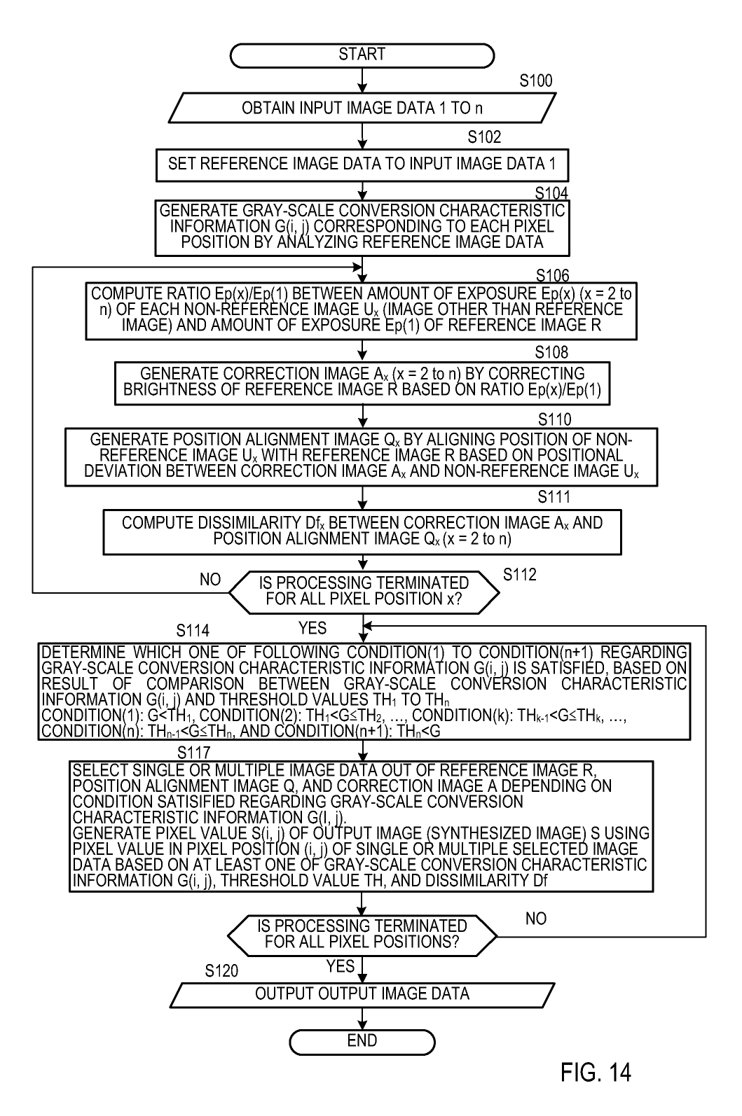

FIG. 14 is a flowchart illustrating a processing sequence of the image synthesis processing executed by the image processing unit 300 according to the third embodiment, in which the same reference numerals denote the same steps as in the first embodiment, and description thereof will not be repeated. According to the third embodiment, compared to the processing sequence of the first embodiment, step S111 is added after step S110, and step S116 is substituted with step S117.

In step S111, the image processing unit 300 computes the dissimilarity Dfₓ between the correction image Aₓ and the position alignment image Qₓ. In step S117, the image processing unit 300 selects a single or a plurality of images from the reference image R, the position alignment images Q₂, . . . , and Qₙ, and the correction images A₂, . . . , and Aₙ depending on a condition satisfied for the gray-scale conversion characteristic information G(i, j). In addition, the image processing unit 300 generates a pixel value S(i, j) of the output image (synthesized image) S using the pixel value at the pixel position (i, j) of a single or a plurality of the selected images.

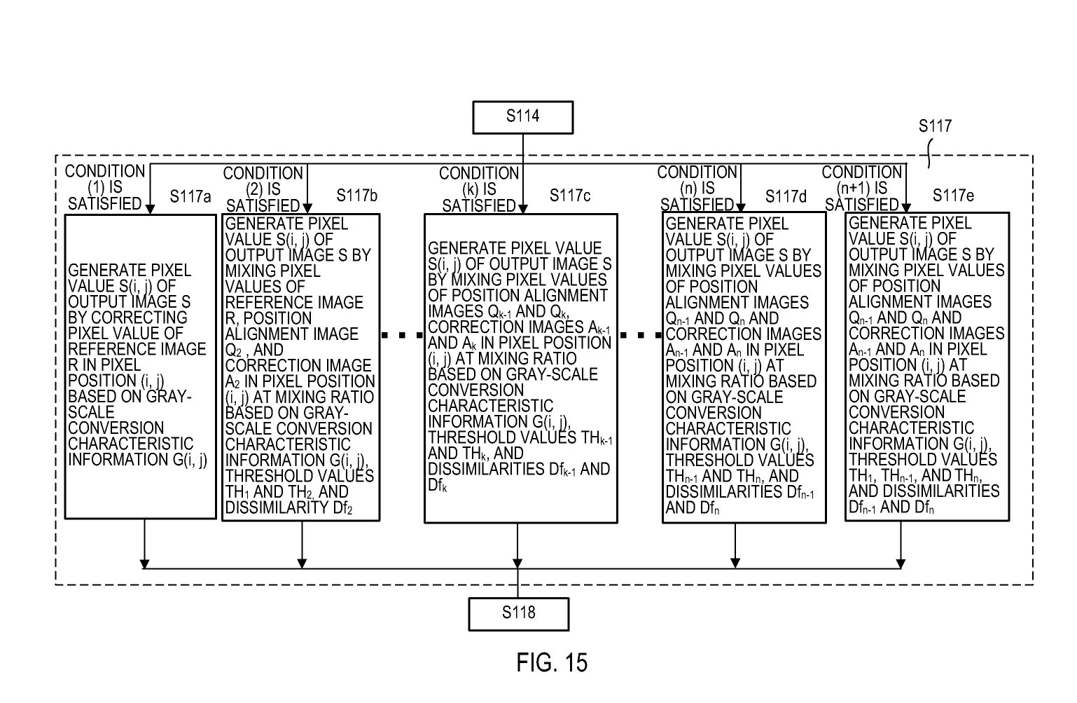

FIG. 15 is a diagram illustrating details of step S117. If Condition(1) is satisfied, in step S117a, the image processing unit 300 generates the pixel value S(i, j) of the output image S by correcting the pixel value of the reference image R at the pixel position (i, j) based on the gray-scale conversion characteristic information G(i, j). That is, the image processing unit 300 computes Equation (2) described above.

If Condition(2) is satisfied, in step S117b, the image processing unit 300 generates the pixel value S(i, j) of the output image S by mixing the pixel values of the reference image R, the position alignment image Q₂, and the correction image A₂ at the pixel position (i, j) at a mixing ratio based on the value of the gray-scale conversion characteristic information G(i, j), the threshold values TH₁ and TH₂, and the dissimilarity Df₂. That is, the image processing unit 300 computes Equations (10) and (11) described above.

In steps S117c and S117d, in a case where Condition(k) (where, k=3 to n) is satisfied, the image processing unit 300 generates the pixel value S(i, j) of the output image S by mixing the pixel values of the position alignment images Qₖ₋₁ and Qₖ and the pixel values of the correction images Aₖ₋₁ and Aₖ in the pixel position (i, j) at a mixing ratio based on the value of the gray-scale conversion characteristic information G(i, j), the threshold values THₖ₋₁ and THₖ, and the dissimilarities Dfₖ₋₁ and Dfₖ. That is, the image processing unit 300 computes Equations (13), (14), or (15) described above.

In step S117e, if Condition(n+1) is satisfied, the image processing unit 300 generate the pixel value S(i, j) of the output image S by mixing the pixel values of the position alignment images Qₙ₋₁ and Qₙ and the pixel values of the correction images Aₙ₋₁ and Aₙ in the pixel position (i, j) at a mixing ratio based on the value of the gray-scale conversion characteristic information G(i, j), the threshold values TH₁, THₙ₋₁, and THₙ, and the dissimilarities Dfₙ₋₁ and Dfₙ. That is, the image processing unit 300 computes Equation (16) described above.

According to the third embodiment, a dissimilarity computation unit 420a computes a dissimilarity Df between the correction image and the non-reference image. The image synthesis processing unit 320 derives a new pixel value by selecting two or more images from the reference image, the position alignment image, and the correction image based on the amplification factor and mixing pixel values of the two or more selected images at a mixing ratio derived based on the amplification factor and the dissimilarity. As a result, it is possible to adjust the mixing ratio of the pixel value of the position alignment image based on the dissimilarity Df.

The image synthesis processing unit 320 mixes pixel values of the position alignment image and the correction image at a mixing ratio derived based on a predetermined function F regarding the dissimilarity Df. As a result, it is possible to adjust a contribution of the pixel value of the position alignment image and a contribution of the pixel value of the correction image for the pixel value of the synthesized image, depending on a positional deviation degree of the position alignment image with respect to the reference image.

The image synthesis processing unit 320 derives the mixing ratio of the position alignment image such that the mixing ratio of the position alignment image increases as the dissimilarity Df decreases. As a result, as the dissimilarity decreases, a contribution of the pixel value of the position alignment image increases. In contrast, as the dissimilarity increases, a contribution of the pixel value of the position alignment image to the pixel value of the synthesized image decreases. Accordingly, it is possible to prevent degradation of the synthesized image caused by a positional deviation of the position alignment image with respect to the reference image.

### Fourth Embodiment

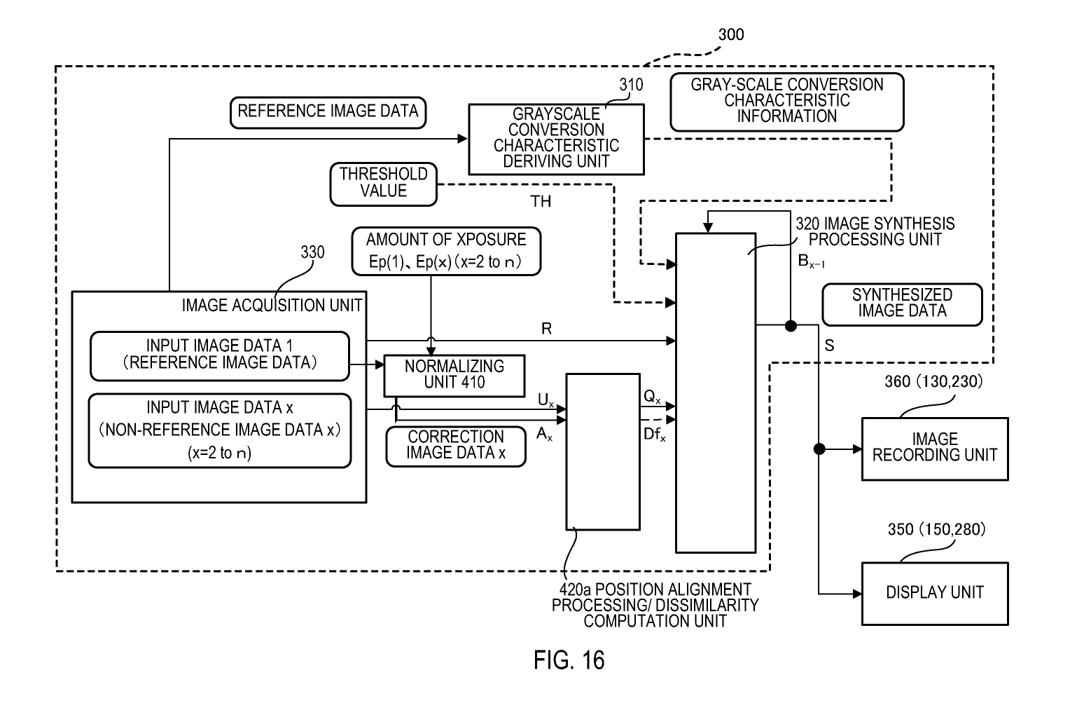

FIG. 16 is a block diagram schematically illustrating a configuration of the image processing unit 300 according to a fourth embodiment. In the third embodiment, the image processing unit 300 generates overall position alignment images Q₂, . . . , and Qₙ used in the image synthesis by the position alignment/dissimilarity computation unit 420a, and the image synthesis is then performed using the image synthesis processing unit 320. However, it may remarkably increase a memory area for storing the position alignment image. In this regard, according to the fourth embodiment, the image synthesis is performed in the image synthesis processing unit 320 whenever a single position alignment image Qₓ is generated. As a result, it is not necessary to store overall position alignment images Q₂, . . . , and Qₙ in a memory such as the memory unit 160, so that the memory area for storing the position alignment image is reduced. The output of the image synthesis processing unit 320 is fed back to the image synthesis processing unit 320, so that the image processing unit 300 performs a feedback (cyclic) processing.

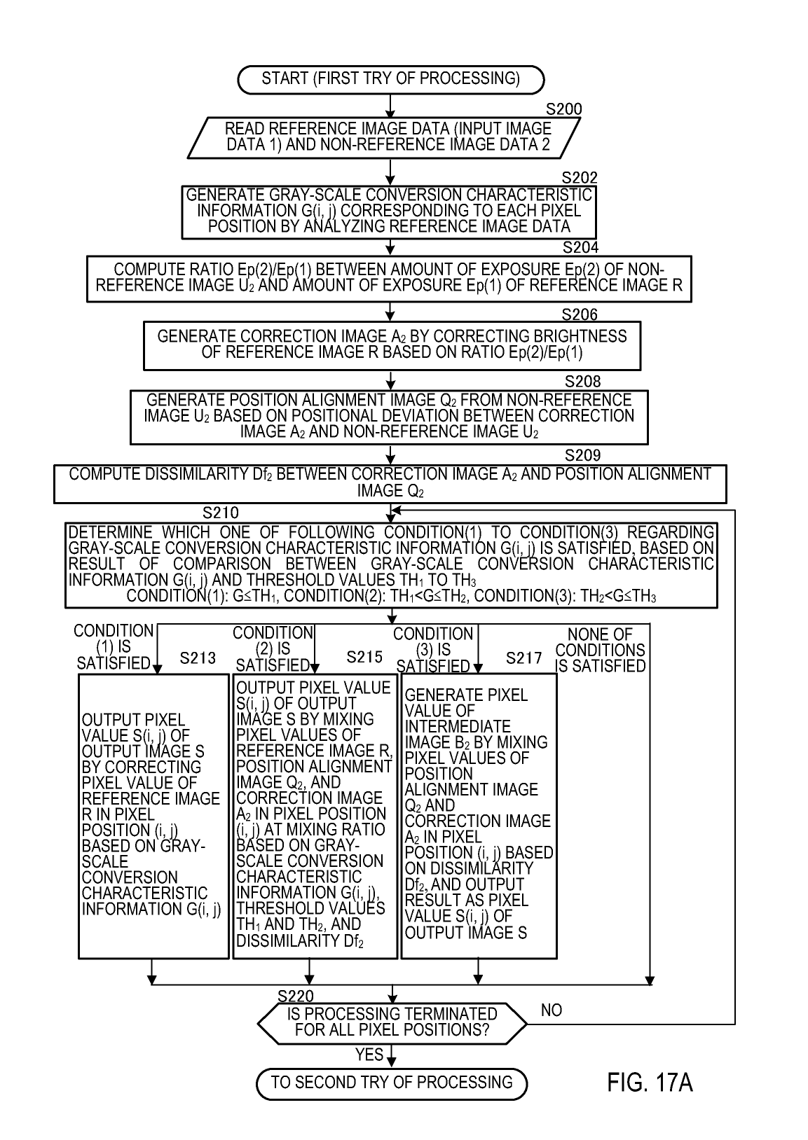

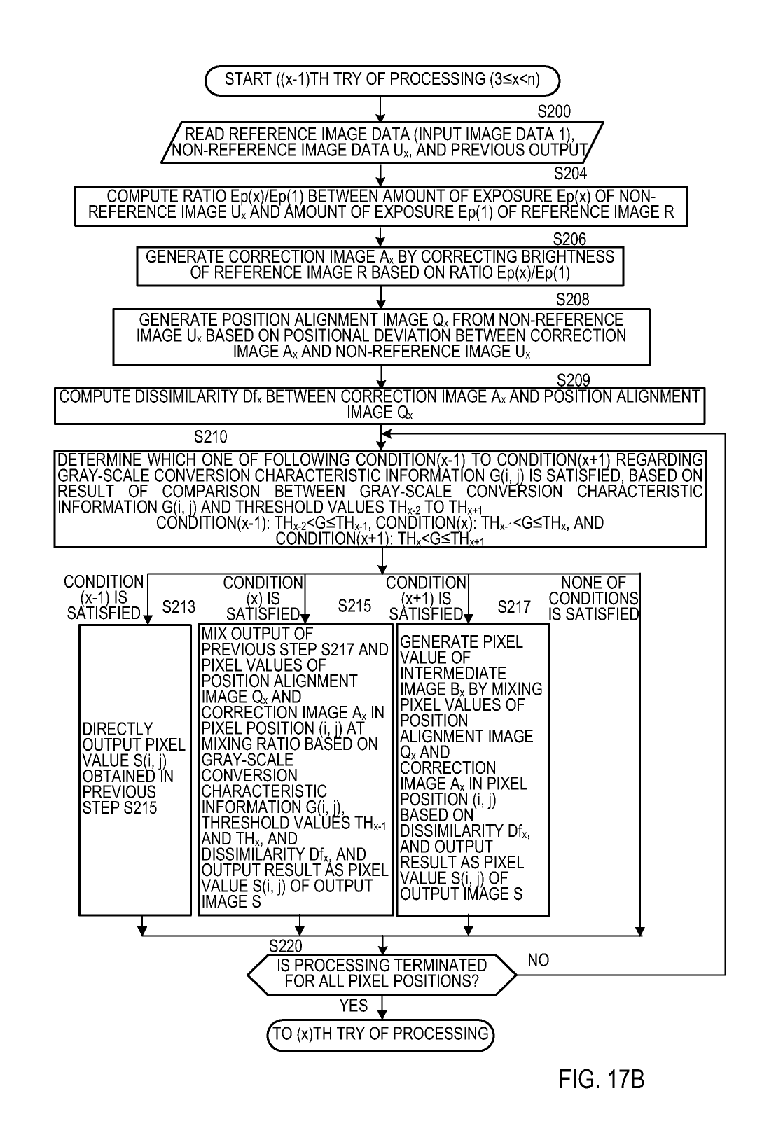

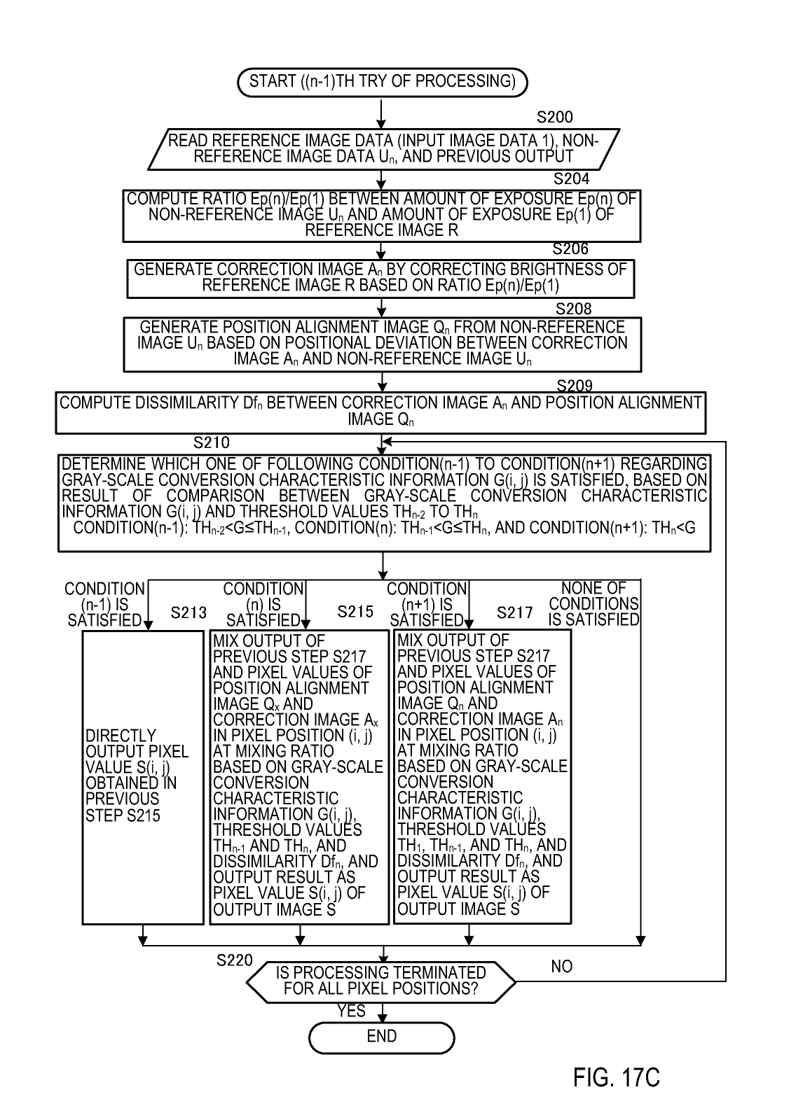

FIGS. 17A to 17C are flowcharts illustrating a processing sequence of the image synthesis processing executed by the image processing unit 300 according to the fourth embodiment. The image synthesis processing executed by the image processing unit 300 in the third embodiment is dividingly executed in a plurality of tries according to the fourth embodiment. The same reference numerals denote the same steps as in the second embodiment, and description thereof will not be repeated. According to the fourth embodiment, compared to the processing sequence of the second embodiment, step S209 is added after step S208, and steps S212, S214, and S216 are substituted with steps S213, S215, and S217, respectively.

FIG. 17A illustrates a first try of the processing in the image processing unit 300. In step S209, the image processing unit 300 computes a dissimilarity Df₂ between the correction image A₂ and the position alignment image Q₂.

If Condition(1) is satisfied in the first try of step S210, in step S213, the image processing unit 300 performs the same processing as that of step S117a to compute Equation (2) described above and output the result. If Condition(2) is satisfied, in step S215, the image processing unit 300 performs the same processing as that of step S117b to compute Equations (10) and (11) described above and output the result. If Condition(3) is satisfied, in step S217, the image processing unit 300 mixes pixel values of the position alignment image Q₂ and the correction image A₂ to generate and output a pixel value of the intermediate image B₂. If none of Condition(1) to Condition(3) is satisfied, the routine advances to step S220 without performing anything.

FIG. 17B illustrates the (x−1)th try subsequent to the first try of the processing performed by the image processing unit 300 for the non-reference image data x (where, 3≦x<n). If Condition(x−1) is satisfied in the (x−1)th try of step S210, in step S213, the image processing unit 300 directly output the pixel value S(i, j) obtained in previous step S215. If Condition(x) is satisfied, the routine advances to step S215. In step S215, the image processing unit 300 mixes pixel values of position alignment image Qₓ and the correction image Aₓ and the output of previous step S217 (intermediate image Bₓ₋₁) at a mixing ratio based on the value of the gray-scale conversion characteristic information G(i, j), the threshold values THₓ₋₁ and THₓ, and the dissimilarity Dfₓ as described in the following Equation (17), and outputs the result as a pixel value S(i, j) of the output image S.

$$\begin{matrix} [ Equation 17 ] & \\ S ( i , j ) = \frac{\{ {TH}_{x} - G ( i , j ) \} * {B}_{x - 1}}{{TH}_{x} - {TH}_{x - 1}} + \frac{\{ G ( i , j ) - {TH}_{x - 1} \} * F ( {Df}_{x} ) * {Q}_{x} ( i , j ) + \{ G ( i , j ) - {TH}_{x - 1} \} * \{ 1 - F ( {Df}_{x} ) \} * {A}_{x} ( i , j )}{{TH}_{x} - {TH}_{x - 1}} & ( 17 )\end{matrix}$$

If Condition(x+1) is satisfied, in step S217, the image processing unit 300 generates a pixel value of the intermediate image Bₓ by mixing pixel values of the position alignment image Qₓ and the correction image Aₓ, and outputs the result. If none of Condition(x−1) to Condition(x+1) is satisfied, the routine advances to step S220 without performing anything.

FIG. 17C illustrates the (n−1)th try of the processing performed by the image processing unit 300. The image processing unit 300 performs the (x−1)th try of the processing in steps S200 to S215 by setting x=n as described above. However, if Condition(n+1) is satisfied in step S210, in step S217, the image processing unit 300 computes Equation (16) described above by performing the same processing as that of step S117e and outputs the result.

According to the fourth embodiment, the image processing unit 300 dividingly executes the image synthesis processing in a plurality of tries. For this reason, the processing scale is reduced, so that it is possible to reduce a capacity of the memory such as the memory unit 160.

In the first to fourth embodiments described above, description has been made for an example in which a pair of input image data are selected based on the gray-scale conversion characteristic information G(i, j), and the pixel values of the input image data are mixed. However, the invention is not limited to such an example. That is, three or more input image data may be selected based on the gray-scale conversion characteristic information G(i, j), and pixel values of the selected input image data may be mixed.

In the first to fourth embodiments described above, the pixel values Pₙ(i, j) of the input image data have not been described in detail for simple and easy description purposes. However, the pixel values Pₙ(i, j) of the input image data may be given as described below. Specifically, in a case where the input image data is so-called RGB image data, the aforementioned processing may be applied to each pixel value of red, green, and blue as the pixel value Pₙ(i, j). In a case where the input image data is represented using a color space such as YCbCr or Lab, the aforementioned processing may be applied to each value of Y, Cb, Cr, L, a, and b as the pixel value Pₙ(i, j) or may be applied only to values Y and L as the pixel value Pₙ(i, j).

In the first to fourth embodiments described above, description has been made for an example in which the threshold values TH₁ to THₙ are set automatically based on the number of exposure and the exposure correction step at the time of a series of exposure bracketing processes or manually by a user setup. In addition, description has been made for a fact that the gray-scale conversion characteristic can be derived in a space-variant manner, and the gray-scale conversion characteristic information G(i, j) can be derived from each of the derived gray-scale conversion characteristics. Alternatively, a single characteristic may be derived from overall reference image data as the gray-scale conversion characteristic, the gray-scale conversion characteristic information G(i, j) corresponding to each pixel position (i, j) may be derived, and the threshold values TH₁ to THₙ may be set in a space-variant manner. In this case, the threshold values TH₁ to THₙ set in a space-variant manner may be derived based on the number of exposure and the exposure correction step at the time of a series of exposure bracketing processes and a result of analyzing the reference image data. Although the threshold values TH₁ to THₙ and the amplification factor G(i, j) as the gray-scale conversion characteristic information are expressed using an antilogarithmic representation in the first to fourth embodiments, they may be given by a logarithmic representation having a base of 2.

The image processing apparatus described above may be mounted on a digital camera, a digital movie camera capable of capturing a still image, a camera-equipped mobile phone, a personal digital assistant (PDA), a portable computer, and the like. The image processing apparatus may be implemented by causing a computer to execute the image processing program.

While embodiments of the present invention have been described, the present invention may be variously changed or modified without departing from the scope or spirit of the present invention. Those skilled in the art would appreciate that such changes and modifications are incorporated into the scope of the invention and equivalents thereof as apparent from the appended claims.

What is claimed is:

1. An image processing apparatus comprising:
a gray-scale conversion characteristic deriving unit that sets a reference image out of a plurality of input images obtained by shooting an identical object with a different amount of exposure and derives a gray-scale conversion characteristic from the reference image;
a normalizing unit that generates a correction image by correcting brightness of the reference image based on an amount of exposure of the reference image and an amount of exposure of a non-reference image other than the reference image;
a position alignment processing unit that computes a positional deviation between the correction image and the non-reference image and generates a position alignment image by aligning a position of the non-reference image with respect to the reference image based on the positional deviation; and
an image synthesis processing unit that derives a new pixel value for each pixel using a pixel value of a single or a plurality of images selected out of the reference image and the position alignment image based on the gray-scale conversion characteristic to generate a synthesized image.

2. The image processing apparatus according to claim 1, wherein the gray-scale conversion characteristic deriving unit derives an amplification factor for each pixel value of the reference image as the gray-scale conversion characteristic, and
the image synthesis processing unit selects two or more images out of the reference image and the position alignment image depending on the amplification factor and mixes pixel values of the two or more selected images at a mixing ratio derived based on the amplification factor to derive the new pixel value.

3. The image processing apparatus according to claim 2, further comprising a dissimilarity computation unit configured to compute a dissimilarity between the correction image and the non-reference image,
wherein the image synthesis processing unit selects the two or more images out of the reference image, the position alignment image, and the correction image based on the amplification factor and mixes pixel values of the two or more selected images at a mixing ratio derived based on the amplification factor and the dissimilarity to derive the new pixel value.

4. The image processing apparatus according to claim 3, wherein the image synthesis processing unit mixes pixel values of the position alignment image and the correction image at a mixing ratio derived based on a predetermined function regarding the dissimilarity.

5. The image processing apparatus according to claim 3, wherein the image synthesis processing unit derives the mixing ratio of the position alignment image such that the mixing ratio of the position alignment image increases as the dissimilarity decreases.

6. The image processing apparatus according to claim 2, wherein the image synthesis processing unit sets a threshold value depending on an amount of exposure set when a plurality of the input images are obtained and mixes pixel values of the two or more selected images at a mixing ratio derived based on the amplification factor and the threshold value.

7. The image processing apparatus according to claim 1, wherein the gray-scale conversion characteristic deriving unit derives the gray-scale conversion characteristic for each of a plurality of areas obtained by dividing the reference image.

8. The image processing apparatus according to claim 1, wherein the position alignment processing unit aligns positions of a plurality of non-reference images with the reference image to generate a plurality of position alignment images, and
the image synthesis processing unit derives a new pixel value for each pixel using pixel values of a single or a plurality of images selected out of a plurality of the position alignment images based on the gray-scale conversion characteristic to generate the synthesized image.

9. An image processing method comprising:
setting a reference image out of a plurality of input images obtained by shooting an identical object with a different amount of exposure;
deriving a gray-scale conversion characteristic from the reference image;
generating a correction image by correcting brightness of the reference image based on an amount of exposure of the reference image and an amount of exposure of a non-reference image other than the reference image;
computing a positional deviation between the correction image and the non-reference image and generating a position alignment image by aligning a position of the non-reference image with respect to the reference image based on the positional deviation; and
deriving a new pixel value for each pixel using a pixel value of a single or a plurality of images selected from the reference image and the position alignment image based on the gray-scale conversion characteristic to generate a synthesized image.

10. A computer readable recording device having an image processing program encoded and recorded thereon in a computer readable format, the image processing program performing a process of generating a synthesized image having an improved gray scale by synthesizing a plurality of input images obtained by shooting an identical object with a different amount of exposure,
wherein the image processing program causes a computer to execute a method comprising:
a reference image setting step of setting a reference image out of a plurality of the input images;
a gray-scale conversion characteristic deriving step of deriving a gray-scale conversion characteristic from the reference image;
a normalizing step of generating a correction image by correcting brightness of the reference image based on an amount of exposure of the reference image and an amount of exposure of a non-reference image other than the reference image;
a position alignment processing step of computing a positional deviation between the correction image and the non-reference image and generating a position alignment image by aligning a position of the non-reference image with respect to the reference image based on the positional deviation; and
an image synthesis step of deriving a new pixel value for each pixel using a pixel value of a single or a plurality of images selected from the reference image and the position alignment image based on the gray-scale conversion characteristic to generate a synthesized image.

11. A photographic imaging apparatus having an image pickup unit capable of photoelectrically converting an object image formed by a photographic lens and outputting an image signal, the photographic imaging apparatus comprising:
a shooting control unit that obtains a plurality of input images by shooting an identical object with a different amount of exposure, using the image pickup unit;
a gray-scale conversion characteristic deriving unit that sets a reference image out of a plurality of the input images and derives a gray-scale conversion characteristic from the reference image;
a normalizing unit that generates a correction image by correcting brightness of the reference image based on the amount of exposure of reference image and an amount of exposure of a non-reference image other than the reference image;
a position alignment processing unit that computes a positional deviation between the correction image and the non-reference image and generates a position alignment image by aligning a position of the non-reference image with the reference image based on the positional deviation; and
an image synthesis processing unit that derives a new pixel value for each pixel using a pixel value of a single or a plurality of images selected from the reference image and the position alignment image based on the gray-scale conversion characteristic to generate a synthesized image.
